(19) United States
(12) Patent Application Publication
(10) Pub. No.: US 2014/0207774 A1
(43) Pub. Date: Jul. 24, 2014

(54) Virtual Building Browser Systems and Methods

(71) Applicants: Mark Walter, Irvine, CA (US); Dale Davis, Clayton, CA (US)

(72) Inventors: Mark Walter, Irvine, CA (US); Dale Davis, Clayton, CA (US)

(21) Appl. No.: 13/749,228

(22) Filed: Jan. 24, 2013

(51) Int. Cl. G06F 17/30

(52) U.S. Cl. CPC G06F 17/30595
USPC 707/736

(57) ABSTRACT

Systems and methods are provided for a virtual building browser with a viewing module displaying images of visible elements and hidden elements, a searchable, relational database configured in a (COBie) compliant format, a query module, and an interface tool for accessing building information management (BIM) data in real-time, monitoring systems to manage facility assets, integration applications linking the searchable database with associated databases, peripheral devices, and user devices. In one embodiment, user devices are iPad® tablet devices with GPS. A computer implemented apparatus for a virtual tour system is also included. Steps for providing a virtual building browser, a virtual tour, and for linking LEED data to a virtual location are included plus computer-implemented methods with computer-usable readable storage medium having computer-readable program code embodied therein for causing a computer system to perform steps for a virtual tour, displaying building information management images of locations are included.

### FIELD OF THE INVENTION

This invention relates generally to the systems and methods of conducting a virtual tour of a location incorporating information pertinent to building operations and management.

### BACKGROUND

The purpose of building commissioning is to provide building owners and operators a high level of assurance that mechanical, electrical, and temperature control systems are installed in the appropriate manner in compliance with the design intent. Commissioning is usually done by third-party contractors, often referred to as the Commissioning Authority, and includes conducting functional tests of systems during and after construction. The Commissioning Authority is typically hired by building owners and maintains the heavy load of commissioning documentation.

Computer software has been implemented by Commissioning Authorities in an attempt to ease the difficulty of the heavy documentation requirements of commissioning. A traditional method implemented by Commissioning Authorities was creating internal commissioning records using desktop software such as MicroSoft Project. However, this method left most of the commissioning data in the hands of the project manager as it did not make use of the now widespread accessibility of the internet. Subsequently, Vela Systems created a web-based commissioning tool that allowed more collaborative, instant reporting of commissioning data. In 2009, Virtual Commissioning, Inc. released a cloud-based commissioning project management software tool called VirtualCx™ that also places the commissioning process within web access in an organized, easy-to-understand format that is searchable, and incorporates a dashboard view with tabbed browsing, task lists, and project milestones. VirtualCx™ has received highly favorable reviews based on its simplicity, low training requirements, and other features. It is currently being used by leading contractors and well-known Silicon Valley high tech firms.

Building commissioning software has mostly been designed to aid new construction and renovation industries, often leaving aside the needs of workers involved in the operations and maintenance of existing buildings. Thus there is a large, untapped market for innovative products and services designed for use by operations and maintenance teams to monitor and record building components beyond their initial construction.

### SUMMARY OF THE INVENTION

According to one embodiment, an apparatus for a virtual tour comprising a viewing module that displays an image of at least one of a visible element and one of a hidden element in a first location on an electronic device; a searchable database comprising a data repository, one or more visible elements, and one or more hidden elements; wherein said searchable database is configured in a Construction Operations Building Information Exchange compliant format and wherein one or more data elements are updated in real time; and a query module wherein one or more data elements are associated with one or more related data elements from the data repository.

According to another aspect of the previous embodiment, at least one or more data elements associated with the virtual tour is stored on a cloud-accessible server.

According to another aspect of the previous embodiments, the viewing module includes a three dimensional building information model (BIM) that further comprises images of visible and hidden elements.

According to another aspect of the previous embodiments, the viewing module displays a hotspot indicator at or near an element image associated with one or more data elements, wherein the hotspot indicator is a discernible symbol visible on the electronic device.

According to another aspect of the embodiments displaying a hotspot indicator, the electronic device display can be touched at or very near the hotspot indicator to activate retrieval of one or more data elements associated with said element image.

According to another aspect of the previous embodiments, the user can navigate through displayed element images on the electronic device using photography software to select a menu item from a group consisting of panning, tilting, and zooming.

According to another aspect of the previous embodiments, an apparatus for a virtual tour comprises a means for transferring data between the electronic device used for the virtual tour to another electronic device.

According to another aspect of the previous embodiments, an apparatus for a virtual tour comprises a means for uploading and storing data and images on the virtual touring device.

According to another aspect of the previous embodiments, an apparatus for a virtual tour comprises user-selected virtual tour images or data.

According to another aspect of the previous embodiments, an apparatus for a virtual tour comprises a reader for 2D and 3D codes such as bar codes and Q codes for controlling access to the virtual tour.

According to another aspect of the previous embodiments, at least one of a brand name and a logo symbol are visible on the electronic device display during the virtual tour.

According to another aspect of the previous embodiments, an apparatus for a virtual tour comprises an alarm module, comprising a user interface for the user to enter one or more boundaries on an element data value, and an alarm signal, wherein the alarm signal is at least one of a sound and an image present on the electronic device when the element data value deviates from user-determined boundaries on the element data value.

According to another aspect of the previous embodiments, an apparatus for a virtual tour comprises a maintenance scheduling module, comprising a user interface for the user to enter at least one scheduled maintenance time for at least one element, and a maintenance signal, wherein the maintenance signal is at least one of a sound and an image present on the electronic device when the current time indicated on the electronic device matches the scheduled maintenance time for an element.

According to another aspect of the previous embodiments, an apparatus for a virtual tour comprises a registration module, comprising a user interface for the user to enter identification information in a database and be designated as at least one of a registered user and administrator, and an access control module for varying each registered user's access to images and data on the electronic device, wherein access for each registered user can be adjusted by one or more administrators.

According to another aspect of the previous embodiments, an apparatus for a virtual tour comprises an electric grid capacity module, comprising data about the current electric grid capacity in the location, a user interface for the user to set one or more boundaries on the current electric grid capacity in the location, and an electric grid capacity signal, wherein the electric grid capacity signal is at least one of a sound and an image present on the electronic device when the value of the current electric grid capacity in the location deviates from the user-determined boundaries on the current electric grid capacity in the location.

According to another aspect of the previous embodiments, an apparatus for a virtual tour comprises an electricity price spike module, comprising data about the current electricity price for the location, a user interface for the user to set one or more boundaries on the current electricity price for the location, and an electricity price signal, wherein the electricity price signal is at least one of a sound and an image present on the electronic device when the current electricity price for the location deviates from the user-determined boundaries on the current electricity price for the location.

According to another aspect of the previous embodiments, the element data in the searchable database is associated with available Leadership in Energy and Environmental Design (LEED) green building data for a corresponding element.

According to another aspect of the previous embodiments, the searchable database comprises one or more reports associated with one or more elements in a location that includes corresponding Leadership in Energy and Environmental Design (LEED) green building information.

According to another aspect of the previous embodiments, an apparatus for a virtual tour comprises a red target as a visible red spot on the electronic device display, wherein the electronic device display can be touched at or very near to a red target to make an element image appear closer on the electronic device.

According to another aspect of the previous embodiments, the viewing module changes the image displayed on the electronic device in response to the user's location, wherein the user's location is determined using global positioning system (GPS) or Google Earth-linked functions.

According to another aspect of the previous embodiments, an internal gyroscope within the electronic device senses changes in the position of the electronic device, and causes changes in the element images displayed on the electronic device in response to these changes in position of the electronic device.

According to another aspect of the previous embodiments, the user interface is a building tour interface for one or more users to access one or more building information management database repositories utilizing a digital computing device.

According to another aspect of the previous embodiment, the digital computing device is an iPad tablet computing device.

According to another aspect of the previous embodiments, an apparatus for a virtual tour further comprises a regulatory module, wherein the regulatory module allows the user or a third-party to associate the element data in the searchable database with updated regulatory data for a corresponding element in the corresponding location.

According to another aspect of the previous embodiments, the updated regulatory data is updated building code data for a corresponding element in the corresponding location.

According to another embodiment, a non-transitory computer-usable readable storage medium for conducting a virtual tour comprises program code for displaying an image of one or more visible elements in a location on an electronic displays, program code for displaying an image of one or more hidden elements in a location on one or more electronic displays, program code for storing and organizing element data in a format based on the approach of the Construction Operations Building Information Exchange, and program code for retrieving the element data for one or more systems of related elements through user interactions with at least one element image on the electronic device.

According to one aspect of the previous embodiment, a non-transitory computer-usable readable storage medium for conducting a virtual tour further comprises: program code for associating one or more source data elements with one or more related target data elements from the data repository; program code for accessing building information status data in real time via one or more peripheral input devices and one or more display devices; program code for linking one or more integration applications to the searchable, relational database with one or more associated databases, wherein the one or more associated databases comprise one or more disparate protocol and one or more disparate domains; program code for associating a virtual tour with a virtual building browser comprising a cloud-based software network application; program code for interfacing the virtual tour with an iPad electronic device and an iPad iOS operating system; program code for populating one or more operation and maintenance manuals into a building information data repository associated with the one or more searchable, relational databases and one or more physical asset elements; program code for tracking a user's movement in a facility where the user is located; and program code for activating a virtual touring application to render the touring application functional.

According to one aspect of the previous embodiment of a non-transitory computer-usable readable storage medium for conducting a virtual tour, the program code for tracking a user's movement in a facility allows for viewing a facility virtual tour by a user who is not physically present in the facility being viewed.

According to one aspect of the previous embodiments, a non-transitory computer-usable readable storage medium for conducting a virtual tour further comprises program code for providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets; program code for viewing on or more hidden elements; program code for providing a three dimensional building information model; program code for providing a video tour model; and program code for associating photography software application with the video tour model to render one or more visible and one or more hidden elements of the facility virtual tour and a related building information model.

According to another embodiment, a method for providing a virtual tour comprises displaying an image of one or more visible elements in a location on an electronic device, displaying an image of one or more hidden elements in a location on an electronic device, storing element data into a database that can organize elements that are Construction Operations Building Information Exchange (COBie) compliant, and retrieving element data for one or more systems of related elements through user interactions with the element images on the electronic device.

According to another aspect of the previous embodiment, the method for providing a virtual tour further comprises associating one or more source data elements with one or more related target data elements from the data repository, accessing building information status data in real time via one or more peripheral input devices and one or more display devices, and linking one or more integration applications to the searchable, relational database with one or more associated databases, wherein the one or more associated databases comprise one or more disparate protocol and one or more disparate domains.

According to another aspect of the previous embodiments, the method for providing a virtual tour further comprises associating a virtual tour with a virtual building browser comprising a cloud-based software network application, interfacing the virtual tour with an iPad electronic device and an iPad iOS operating system, populating one or more operation and maintenance manuals into a building information data repository associated with the one or more searchable, relational databases and one or more physical asset elements, tracking a user's movement in a facility where the user is located, and activating a virtual touring application to render the touring application functional.

According to another aspect of the previous embodiments, in the method for providing a virtual tour tracking a user's movement in a facility allows for viewing a facility virtual tour by a user who is not physically present in the facility being viewed.

According to another aspect of the previous embodiments, the method for providing a virtual tour further comprises providing an operating mode for touring while physically located within a facility with physical asset elements associated with the one or more searchable, relational databases and that includes a selected point of reference location to subsequently create a facility profile, wherein said operating mode is selected from the group consisting of a manual mode, auto-locate mode, and a global positioning system (GPS) mode.

According to another aspect of the previous embodiments, in the method for providing a virtual tour, the manual mode includes a manually selected point of reference location.

According to another aspect of the previous embodiments, in the method for providing a virtual tour, the auto-locate feature determines the facility location of one or more pre-identified, recognized facility assets.

According to another aspect of the previous embodiments, in the method for providing a virtual tour the GPS mode includes a GPS device integrated with the iPad iOS operating system.

According to another aspect of the previous embodiments, the method for providing a virtual tour further comprises providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets.

According to another aspect of the previous embodiments, the method for providing a virtual tour further comprises viewing one or more hidden elements.

According to another aspect of the previous embodiments, the method for providing a virtual tour further comprises providing a three dimensional building information model.

According to another aspect of the previous embodiments, the method for providing a virtual tour further comprises providing a video tour model, and associating photography software application with the video tour model to render one or more visible and one or more hidden elements of the facility virtual tour and a related building information model.

According to another embodiment, a virtual touring system comprises a database module that organizes element data that is Construction Operations Building Information Exchange compliant, a viewing module that displays images of one or more visible elements and one or more hidden elements in a location on an electronic device, and a data retrieval module for fetching element data from the database module in response to user interaction with the viewing module.

According to another aspect of the previous embodiment, the virtual touring system further comprises: a searchable, relational database comprising a data repository, one or more visible elements and one or more hidden elements, wherein said searchable, relational database is configured in a Construction Operations Building Information Exchange (COBie) compliant format wherein the COBie compliant data is synchronized with one or more additional COBie compliant searchable, relational databases and wherein one or more data elements are updated in real time; a query module wherein one or more data elements are associated with one or more related data elements from the data repository; an access interface tool for retrieving and updating building information status data in real-time; one or more control monitoring systems of maintenance, repair, and operation data to manage facility assets; one or more integration applications to link the searchable database with one or more associated databases; one or more peripheral input devices; and one or more display devices.

According to another aspect of the previous embodiments, the virtual touring system further comprises a cloud-based software network application.

According to another aspect of the previous embodiments, in the virtual touring system the access interface tool for retrieving and updating building information status data in real-time is an asset management tool.

According to another aspect of the previous embodiments, in the virtual touring system the viewing module that displays an image of at least one of a visible element and one of a hidden element in a first location on an electronic device is a touring application.

According to another embodiment, one or more processor-readable storage devices having processor readable code embodied on at least one processor readable storage device, said processor readable code causes at least one processor readable storage device to perform a method of conducting a virtual tour comprising steps for displaying an image of one or more visible elements in a location on an electronic device, displaying an image of one or more hidden elements in a location on an electronic device, storing element data into a database that can organize systems of related elements based on the approach of the Construction Operations Building Information Exchange, and retrieving element data for one or more systems of related elements from the database in response to user interactions with the element images on the electronic device.

According to another aspect of the previous embodiment, said processor readable code causes at least one processor readable storage device to perform a method of conducting a virtual tour, further comprising steps for associating one or more source data elements with one or more related target data elements from the data repository, accessing building information status data in real time via one or more peripheral input devices and one or more display devices, and linking one or more integration applications to the searchable, relational database with one or more associated databases, wherein the one or more associated databases comprise one or more disparate protocol and one or more disparate domains.

According to another aspect of the previous embodiments, said processor readable code causes at least one processor readable storage device to perform a method of conducting a virtual tour, further comprising steps for associating a virtual tour with a virtual building browser comprising a cloud-based software network application, interfacing the virtual tour with an iPad electronic device and an iPad iOS operating system, populating one or more operation and maintenance manuals into a building information data repository associated with the one or more searchable, relational databases and one or more physical asset elements, tracking a user's movement in a facility where the user is located, and activating a virtual touring application to render the touring application functional.

According to another aspect of the previous embodiments, said processor readable code causes at least one processor readable storage device to perform a method of conducting a virtual tour, further comprising steps for: providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets; providing an iPad electronic tablet device integrated with the iPad iOS operating system; viewing one or more hidden elements; providing a three dimensional building information model; providing a video tour model; and associating photography software application with the video tour model to render one or more visible and one or more hidden elements of the facility virtual tour and a related building information model.

According to another embodiment, a computer-implemented method includes computer-usable readable storage medium having computer-readable program code embodied therein for causing a computer system to perform a method of providing a system for a virtual tour comprising steps for: displaying an image of one or more visible elements in a location on an electronic device; displaying an image of one or more hidden elements in a location on an electronic device; storing element data into a database that can organize elements based on the approach of the Construction Operations Building Information Exchange; and retrieving element data for one or more systems of related elements through user interactions with the element images on the electronic device.

According to an aspect of the previous embodiment, the computer-implemented method includes computer-usable readable storage medium having computer-readable program code embodied therein for causing a computer system to perform a method of providing a system for a virtual tour comprising steps for associating one or more source data elements with one or more related target data elements from the data repository, accessing building information status data in real time via one or more peripheral input devices and one or more display devices, and linking one or more integration applications to the searchable, relational database with one or more associated databases, wherein the one or more associated databases comprise one or more disparate protocol and one or more disparate domains.

According to an aspect of the previous embodiments, the computer-implemented method includes computer-usable readable storage medium having computer-readable program code embodied therein for causing a computer system to perform a method of providing a system for a virtual tour comprising steps for associating a virtual tour with a virtual building browser comprising a cloud-based software network application, interfacing the virtual tour with an iPad electronic device and an iPad iOS operating system, populating one or more operation and maintenance manuals into a building information data repository associated with the one or more searchable, relational databases and one or more physical asset elements, tracking a user's movement in a facility where the user is located, and activating a virtual touring application to render the touring application functional.

According to another aspect of the previous embodiments, the computer-implemented method includes computer-usable readable storage medium having computer-readable program code embodied therein for causing a computer system to perform a method of providing a system for a virtual tour comprising steps for providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets, providing an iPad electronic tablet device integrated with the iPad iOS operating system, viewing on or more hidden elements, providing a three dimensional building information model, providing a video tour model, and associating photography software application with the video tour model to render one or more visible and one or more hidden elements of the facility virtual tour and a related building information model.

According to another embodiment, a computer-implemented platform including a non-transitory computer-usable readable storage medium having non-transitory computer-readable program codes embodied therein for causing a computer system to provide steps for a virtual tour system comprises a custom computer platform for a virtual building browser, a user interface module having a display, wherein the display graphically associates one or more data elements from a relational, searchable database with one or more physical assets in a building information model, the relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time, a query module wherein one or more data elements are associated with one or more related data elements from the data repository, an access interface tool for retrieving and updating building information status data in real-time, one or more control monitoring systems of maintenance, repair, and operation data to manage facility assets, one or more integration applications to link the searchable database with one or more associated databases, one or more peripheral input devices, and one or more display devices.

According to another embodiment, a computer-implemented apparatus for providing a method of performing a virtual tour, said apparatus comprises a viewing module that displays an image of at least one of a visible element and one of a hidden element in a first location on an electronic device, a searchable database comprising a data repository, one or more visible elements and one or more hidden elements, wherein said searchable database is configured in a Construction Operations Building Information Exchange (COBie) compliant format and wherein one or more data elements are updated in real time, and a query module wherein one or more data elements are associated with one or more related data elements from the data repository, wherein at least one or more data elements associated with the virtual tour is stored on a cloud-accessible server, and wherein the viewing module includes a three dimensional building information model (BIM) that further comprises images of visible and hidden elements wherein the viewing module indicates an element image associated with one or more data elements by displaying a hotspot indicator near the element image, wherein the hotspot indicator is a discernible, visible symbol on the electronic device.

According to another embodiment, a method for displaying a building information management image of a location on an electronic device comprises: providing at least one of a 2D and 3D image associated with one or more physical assets configured in a searchable, relational database and further associated with extended information attributes of the one or more physical assets discoverable by an iPad electronic tablet device integrated with an iPad iOS operating system; displaying visible elements; indicating hidden elements; changing a page view of said hidden elements and said visible elements associated with a point of reference location in real time; changing a page view of said hidden elements and said visible elements associated with a point of reference of the iPad electronic tablet device orientation in real time wherein said iPad electronic tablet device orientation is determined with respect to a three dimensional axis to a point in space; providing a visual mark substantially near one or more elements linked to element data stored in a database; and retrieving element data from a database in response to a user's interaction with the electronic device.

According to another aspect of the previous embodiment, in the method for displaying a building information management image of a location on an electronic device the point of reference location is a user physical location.

According to another aspect of the previous embodiments, in the method for displaying a building information management image of a location on an electronic device the point of reference location is a user virtual location.

According to another aspect of the previous embodiments, in the method for displaying a building information management image of a location on an electronic device the point of reference location is a user virtual location determined by a GPS embedded software application.

According to another embodiment, a method for viewing building operations data comprises steps for: associating one or more source data elements with one or more related target data elements from the data repository; accessing building information status data in real time via one or more peripheral input devices and one or more display devices; linking one or more integration applications to the searchable, relational database with one or more associated databases, wherein the one or more associated databases comprise one or more disparate protocol and one or more disparate domains; associating a virtual tour with a virtual building browser comprising a cloud-based software network application, interfacing the virtual tour with an iPad electronic device and an iPad iOS operating system; populating one or more operation and maintenance manuals into a building information data repository associated with the one or more searchable, relational databases and one or more physical asset elements; tracking a user's movement in a facility where the user is located; activating a virtual touring application to render the touring application functional; providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets; providing an iPad electronic tablet device integrated with the iPad iOS operating system; viewing on or more hidden elements; providing a three dimensional building information model; providing a video tour model; and associating photography software application with the video tour model to render one or more visible and one or more hidden elements of the facility virtual tour and a related building information model.

According to another embodiment, a method for linking green building data to a virtual rendering of a location comprises: linking Leadership in Energy and Environmental Design (LEED) information to a symbol visible on an electronic device display substantially near an element; creating a LEED credit report using element images and element data; providing one or more Leadership in Energy and Environmental Design attributes for green building and facilities operations practices, one or more LEED certification program attributes for existing and new construction; providing a link symbol for each one or more attribute to an external website with extended information about that element or sub-system, wherein said external website is associated with a custom computer platform for a virtual building browser; associating one or more data elements from a relational, searchable database with one or more physical assets in a building information model; providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time; providing a query module wherein one or more data elements are associated with one or more related data elements from the data repository; retrieving and updating building information status data in real-time; providing one or more control monitoring systems of maintenance, repair, and operation data to manage facility assets; providing one or more integration applications to link the searchable database with one or more associated databases; accessing one or more peripheral input devices; and displaying building information data on one or more electronic devices.

According to another embodiment, a method for linking green building data to a database of information about elements in a location comprises: updating a database of element data with associated LEED information linked to specific elements with keywords; linking LEED information to the element data stored on the database; creating a LEED credit report using visual images and data stored in the database; incorporating a signal on virtual building browser that indicates when an associated electric grid capacity is high; incorporating a signal on the virtual building browser that indicates when electricity prices are high; providing one or more Leadership in Energy and Environmental Design attributes for green building and facilities operations practices, and one or more LEED certification program attributes for existing and new construction; providing a link symbol for each one or more attribute to an external website with extended information about that element or sub-system, wherein said external website is associated with a custom computer platform for a virtual building browser; associating one or more data elements from a relational, searchable database with one or more physical assets in a building information model; providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time; providing a query module wherein one or more data elements are associated with one or more related data elements from the data repository; retrieving and updating building information status data in real-time; providing one or more control monitoring systems of maintenance, repair, and operation data to manage facility assets; providing one or more integration applications to link the searchable database with one or more associated databases; accessing one or more peripheral input devices; and displaying building information data on one or more electronic devices.

According to another embodiment, a method for linking a virtual touring device to regulatory data about elements in a location comprises: updating a database of element data with associated building code information linked to specific elements with keywords; linking building code information to the element data stored on the database; creating a building code test report using visual images and data stored in the database; providing one or more building code attributes for existing and new construction; providing a link symbol for each one or more attribute to an external website with extended information about that element or sub-system, wherein said external website is associated with a custom computer platform for a virtual building browser; associating one or more data elements from a relational, searchable database with one or more physical assets in a building information model; providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time; providing a query module wherein one or more data elements are associated with one or more related data elements from the data repository; retrieving and updating building information status data in real-time; providing one or more control monitoring systems of maintenance, repair, and operation data to manage facility assets; providing one or more integration applications to link the searchable database with one or more associated databases; accessing one or more peripheral input devices; and displaying building information data on one or more electronic devices.

According to another embodiment, a virtual building browser comprises a viewing module that displays an image of at least one of a visible element and one of a hidden element in a first location on an electronic device; a searchable, relational database comprising a data repository, one or more visible elements and one or more hidden elements, wherein said searchable database is configured in a Construction Operations Building Information Exchange compliant format and wherein one or more data elements are updated in real time; a query module wherein one or more data elements are associated with one or more related data elements from the data repository; an access interface tool for retrieving and updating building information status data in real-time; one or more control monitoring systems of maintenance, repair, and operation data to manage facility assets; one or more integration applications to link the searchable database with one or more associated databases; one or more peripheral input devices; and one or more display devices.

According to another aspect of the previous embodiment, a virtual building browser further comprises a cloud-based software network application.

According to another aspect of the previous embodiments, the access interface tool for retrieving and updating building information status data in real-time is an asset management tool.

According to another aspect of the previous embodiments, the asset management tool populates one or more searchable operation and maintenance manuals into the building information status data repository during the design and construction process.

According to another aspect of the previous embodiments, the viewing module that displays an image of at least one of a visible element and one of a hidden element in a first location on an electronic device, is a touring application.

According to another aspect of the previous embodiments, a virtual building browser further comprises an iPad iOS operating system interface; an operating mode, located in a facility wherein the user is located and that is used for tracking a user's movement, includes a selected point of reference location and a subsequently tracked user's facility movement profile; and an activation selector that is in the open position to render the touring application functional.

According to another aspect of the previous embodiments, the operating mode is one of either a manual mode that includes a manually selected point of reference location or an auto-locate feature that determines the facility location of one or more pre-identified, recognized facility assets.

According to another aspect of the previous embodiments, a virtual building browser further comprises a global positioning system (GPS) mode for tracking a user's movement in a facility wherein the user is located by a GPS device integrated with the iPad iOS operating system, the auto-locate feature and the manual mode described above.

According to another aspect of the previous embodiments, a virtual building browser further comprises a hotspot indicator to associate one or more facility assets with one or more database elements, wherein the hotspot indicator may be configured to open a separate dialog box to render extended information related to the associated one or more database elements with the corresponding one or more facility assets in a physical location substantially adjacent to the corresponding one or more facility assets.

According to another aspect of the previous embodiments, a user located in the facility in a stationary position can view one or more hidden elements.

According to another aspect of the previous embodiments, a virtual building browser further comprises a three dimensional building information model (BIM).

According to another aspect of the previous embodiments, a virtual building browser further comprises a video tour model.

According to another aspect of the previous embodiments, a virtual building browser further comprises a photography software application associated with the video tour model to render one or more visible and one or more hidden elements of the virtual building browser and wherein the photography software integrates to one or more of the searchable, relational database elements to associate viewable elements in the video tour model with associated extended information in the one or more visible and the one or more hidden elements of the virtual building browser.

According to another aspect of the previous embodiments, a virtual building browser further comprises photography software that alternatively includes pan, tilt and zoom functions, to view live and archived data of the one or more visible and one or more hidden elements of the virtual building browser by tapping a hotspot indicator.

According to another aspect of the previous embodiments, a virtual building browser further comprises a regulatory module, wherein the regulatory module allows the user or a third-party to associate the element data in the searchable database with updated regulatory data for a corresponding element in the corresponding location.

According to another aspect of the previous embodiments, the updated regulatory data is updated building code data for a corresponding element in the corresponding location.

According to another embodiment, a method for synchronizing two or more users to simultaneously access extended information about a field site from one or more remote locations, comprises: displaying an image of one or more visible elements in a location on two or more electronic devices; displaying an image of one or more hidden elements in a location on two or more electronic devices; storing element data into a database that can organize elements that are Construction Operations Building Information Exchange compliant; retrieving element data for one or more systems of related elements through each user's interactions with the element images on each of the two or more electronic devices; associating one or more source data elements with one or more related target data elements from the data repository; accessing building information status data in real time via one or more peripheral input devices and one or more display devices; linking one or more integration applications to the searchable, relational database with one or more associated databases, wherein the one or more associated databases comprise one or more disparate protocols and one or more disparate domains; associating at least one electronic device with a cloud-based software network application; and populating one or more operation and maintenance manuals into a building information data repository associated with the one or more searchable, relational databases and one or more physical asset elements.

According to another aspect of the previous embodiment, at least one electronic device is an iPad electronic device with an iPad iOS operating system.

According to another aspect of the previous embodiments, in the method for synchronizing two or more users to simultaneously access extended information about a field site from one or more remote locations, one electronic device is tracking a user's movement in a facility where the user is located, allowing remote viewing of a facility by a user who is not physically present in the facility being viewed.

According to another embodiment, a method for directly comparing a virtual rendering and commissioning data from two different locations comprises: displaying an image of one or more visible and hidden elements in a first location on an electronic device; displaying an image of one or more visible and hidden elements in a second location on the same electronic device; storing element data for each location into a database that can organize elements that are Construction Operations Building Information Exchange compliant; retrieving element data for one or more systems of related elements through each user's interactions with the element images on the electronic device; associating one or more source data elements with one or more related target data elements from the data repository; accessing building information status data in real time via one or more peripheral input devices and one or more display devices; linking one or more integration applications to the searchable, relational database with one or more associated databases, wherein the one or more associated databases comprise one or more disparate protocols and one or more disparate domains; associating the electronic device with a cloud-based software network application; and populating one or more operation and maintenance manuals into a building information data repository associated with the one or more searchable, relational databases and one or more physical asset elements.

According to another aspect of the previous embodiment, the electronic device is an iPad electronic device with an iPad iOS operating system.

According to another aspect of the previous embodiments, in a method for directly comparing a virtual rendering and commissioning data from two different locations, the electronic device is tracking a user's movement in a facility where the user is located, wherein tracking a user's movement in a facility allows remote viewing of a facility by a user who is not physically present in the facility being viewed.

According to another embodiment, an apparatus for a virtual building browser database, comprises: (1) a building object, further comprising a building identification field, a building name field, one or more address fields, and a user-defined building information field; (2) one or more building owner network objects corresponding to the building object, each further comprising a building owner network identification field, an owner identification field, the building identification field, and a user-defined building owner network information field; (3) an owner object corresponding to one or more building owner network objects, further comprising the corresponding owner identification field, one or more owner name fields, one or more owner contact fields, one or more owner phone fields, and a user-defined owner information field; (4) a facility network object corresponding to the building object, further comprising a facility network identification field, a facility identification field, the building identification field, and a user-defined facility network information field; (5) a facility object corresponding to one or more facility network objects, further comprising the corresponding facility identification field, a facility name field, and at least one facility location field; (6) one or more floor objects corresponding to the building object, each further comprising a floor identification field, the building identification field, a floor name field, a floor area field, and a user-defined floor information field; (7) one or more location objects corresponding to a floor object, each further comprising a location identification field, the floor identification field, a location name field, a geo-location field, a location area field; and a user-defined location information field; (8) one or more plant location objects corresponding to a location object, each further comprising a plant location identification field, the location identification field, a plant identification field, and a user-defined plant location information field; (9) a plant object corresponding to one or more plant location objects, further comprising the corresponding plant identification field, a parent-plant identification field, at least one plant name field, a manufacture identification field, a product code field, and a user-defined plant information field; (10) a manufacturer object corresponding to one or more plant objects, further comprising the corresponding manufacturer identification field, at least one manufacturer name field, a contact field, and a user-defined manufacturer information field.

According to another aspect of the previous embodiment, the virtual building browser database is a virtual asset management system.

According to another embodiment, a method of providing a virtual building browser database comprises: (1) providing one or more elements related to a project overview; (2) providing one or more elements related to the owner's project requirements; (3) providing one or more elements related to a basis of design; (4) providing an as-builts tool, further comprising one or more elements related to as-builts, one or more elements related to construction drawings, one or more elements related to specifications, and one or more elements related to building information modeling, one or more images, one or more elements related to global positioning system information, and one or more elements related to radio frequency identification tags; (5) providing a general performance tool, further comprising one or more elements related to general performance of building systems, one or more elements related to building design, one or more elements related to actual performance of building systems, one or more elements related to building commissioning, one or more elements related to system performance history, and one or more elements related to project benchmarks; (6) providing a general operations and maintenance tool, further comprising one or more elements related to general operations and maintenance, one or more elements related to standard operating procedures, one or more elements related to an emergency operations plan, one or more elements related to maintenance, one or more elements related to stock, and one or more elements related to warranty information; (7) providing a reports tool, further comprising predictive failure information, project benchmarks information, legacy information, energy use information, preventative maintenance information, and alarm information.

According to another aspect of the previous embodiment, the virtual building browser database is a visual asset management system.

According to another embodiment, a method of providing a virtual building browser database comprises: (1) providing a design module, further comprising one or more elements related to a project overview, one or more elements related to the owner's project requirements, one or more elements related to a basis of design, one or more elements related to as-builts, one or more elements related to construction drawings, one or more elements related to building design, one or more elements related to specifications, and one or more elements related to building information modeling; (2) providing a construction module, further comprising one or more elements related to general operations and maintenance, one or more elements related to maintenance, one or more elements related to stock, and one or more elements related to warranty information; (3) providing commissioning module, further comprising one or more images, one or more elements related to global positioning system information, one or more elements related to radio frequency identification tags, one or more elements related to general performance of building systems, one or more elements related to actual performance of building systems, one or more elements related to building commissioning, one or more elements related to system performance history, one or more elements related to project benchmarks, one or more elements related to standard operating procedures, one or more elements related to an emergency operations plan, and a reports tool, further comprising predictive failure information, project benchmarks information, legacy information, energy use information, preventative maintenance information, and alarm information.

According to another aspect of the previous embodiment, the virtual building browser database is a visual asset management system.

According to another embodiment, an apparatus for a virtual building browser database comprises: (1) one or more elements related to a project overview; (2) one or more elements related to the owner's project requirements; (3) one or more elements related to a basis of design; (4) an as-builts tool, further comprising one or more elements related to as-builts, one or more elements related to construction drawings, one or more elements related to specifications, and one or more elements related to building information modeling, one or more images, one or more elements related to global positioning system information, and one or more elements related to radio frequency identification tags; (5) a general performance tool, further comprising one or more elements related to general performance of building systems, one or more elements related to building design, one or more elements related to actual performance of building systems, one or more elements related to building commissioning, one or more elements related to system performance history, and one or more elements related to project benchmarks; (6) a general operations and maintenance tool, further comprising one or more elements related to general operations and maintenance, one or more elements related to standard operating procedures, one or more elements related to an emergency operations plan, one or more elements related to maintenance, one or more elements related to stock, and one or more elements related to warranty information; (7) a reports tool, further comprising predictive failure information, project benchmarks information, legacy information, energy use information, preventative maintenance information, and alarm information.

According to another aspect of the previous embodiment, the virtual building browser database is a visual asset management system.

According to another embodiment, an apparatus for a virtual building browser database comprises: (1) a design module, further comprising one or more elements related to a project overview, one or more elements related to the owner's project requirements, one or more elements related to a basis of design, one or more elements related to as-builts, one or more elements related to construction drawings, one or more elements related to building design, one or more elements related to specifications, and one or more elements related to building information modeling; (2) a construction module, further comprising one or more elements related to general operations and maintenance, one or more elements related to maintenance, one or more elements related to stock, and one or more elements related to warranty information; (3) a commissioning module, further comprising one or more images, one or more elements related to global positioning system information, one or more elements related to radio frequency identification tags, one or more elements related to general performance of building systems, one or more elements related to actual performance of building systems, one or more elements related to building commissioning, one or more elements related to system performance history, one or more elements related to project benchmarks, one or more elements related to standard operating procedures, one or more elements related to an emergency operations plan, and a reports tool, further comprising predictive failure information, project benchmarks information, legacy information, energy use information, preventative maintenance information, and alarm information.

According to another aspect of the previous embodiment, the virtual building browser database is a visual asset management system.

### BRIEF DESCRIPTION OF THE DRAWINGS

FIG. 1 is a functional block diagram of an apparatus for a virtual tour.

FIG. 2 is a functional block diagram of a non-transitory computer-usable readable storage medium for conducting a virtual tour.

FIG. 3 is a flow chart for a method for providing a virtual tour.

FIG. 4 is a diagram for a virtual touring system.

FIG. 5 is a flow chart for one or more processor-readable storage devices having processor readable code embodied on at least one processor readable storage device for causing at least one processor readable storage device to perform a method of conducting a virtual tour.

FIG. 6 is a flow chart for a computer implemented method including non-transitory computer-usable readable storage medium having non-transitory computer-readable program code therein for causing a computer system to perform a method of providing a system for a virtual tour.

FIG. 7 is a functional block diagram of a computer-implemented platform comprising a non-transitory computer-usable readable medium having non-transitory computer-readable program codes embodied therein for causing a computer system to provide steps for a virtual tour system.

FIG. 8 is a computer-implemented apparatus for providing a method of performing a virtual tour.

FIG. 9 is a flow chart for displaying a building information modeling image of a location on an electronic device.

FIG. 10 is a flow chart for providing steps for viewing building operations data.

FIG. 11 is a flow chart for providing steps for linking green building data to a virtual rendering of a location.

FIG. 12 is a flow chart for providing steps for linking green building data to a database of information about elements in a location.

FIG. 13 is a flow chart for providing steps for linking a virtual touring device to regulatory compliance information for at least one of an element and a system.

FIG. 14 is a block diagram illustrating components of a virtual building browser.

FIG. 15 is a flow chart for providing steps for synchronizing two or more users to simultaneously access extended information about a field site from one or more remote locations.

FIG. 16 is a flow chart for providing steps for directly comparing a virtual rendering and commissioning data from two different locations.

FIG. 17 is a block diagram illustrating an apparatus for a virtual building browser database.

FIG. 18 is a flow chart of a method for providing a virtual building browser database.

FIG. 19 is a flow chart of a method for providing a virtual building browser database.

FIG. 20 is a block diagram illustrating a system for providing a virtual browser database.

FIG. 21 is a block diagram illustrating an apparatus for a virtual building browser database.

FIG. 22 is a block diagram illustrating components of an exemplary operating environment.

FIG. 23 is a functional block diagram of an exemplary computer system.

### DETAILED DESCRIPTION OF EXAMPLE EMBODIMENTS OF THE INVENTION

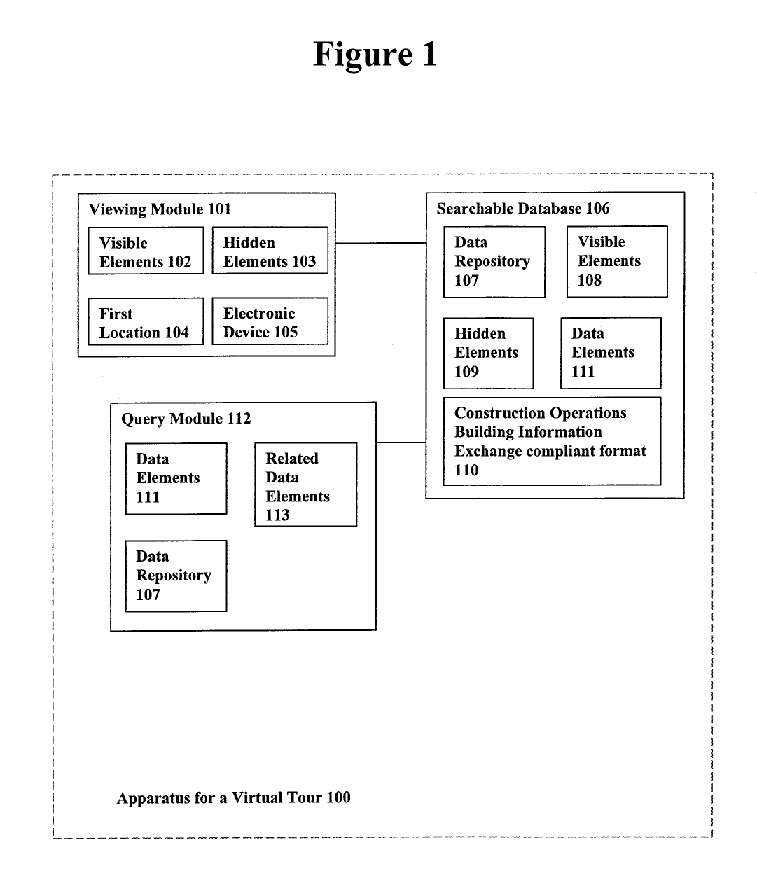

According to one embodiment, as shown in FIG. 1, an apparatus for a virtual tour 100 comprises: a viewing module 101 that displays an image of at least one of a visible element 102 and one of a hidden element 103 in a first location 104 on an electronic device 105; a searchable database 106 further comprising a data repository 107, one or more visible elements 108, and one or more hidden elements 109; wherein said searchable database 106 is configured in a Construction Operations Building Information Exchange compliant format 110 and wherein one or more data elements 111 are updated in real time; and a query module 112 wherein one or more data elements 111 are associated with one or more related data elements 113 from the data repository 107.

According to further aspects of the apparatus for a virtual tour 100, at least one or more data elements 111 are associated with the virtual tour apparatus 100 and stored on a cloud-accessible server 114. According to another aspect of the apparatus for a virtual tour 100, the viewing module 101 includes a three dimensional building information model (BIM) 115 that further comprises images of visible 102 and hidden 103 elements. In other certain aspects, the viewing module displays a hotspot indicator 116 substantially near an element image 102,103 associated with one or more data elements 111, wherein the hotspot indicator 116 is a discernible, visible symbol 117 on the electronic device 105. According to another aspect of the embodiments displaying a hotspot indicator 116, the electronic device display 118 can be touched substantially near the hotspot indicator to activate retrieval of one or more data elements 111 associated with said element image 102,103.

According to other various aspects of the apparatus for a virtual tour 100, the user can navigate through displayed element images on the electronic device 105 using photography software 119 to select a menu item 120 from a group consisting of panning 121, tilting 122, and zooming 123. In other various aspects of the apparatus for a virtual tour 100, an apparatus for a virtual tour comprises a means for transferring data between the electronic device used for the virtual tour 124 to another electronic device 125, an apparatus for a virtual tour 100 further comprises a means for uploading and storing data and images 126 on a virtual touring device 127. Means for transferring data between electronic devices could involve the use of a network interface card or a data port such as USB, IEEE 1394 or FireWire, Thunderbolt, Ethernet, PS/2, VGA, Digital User Interface, SCSI, HDMI, MiniJack or other serial or parallel data ports. Means for uploading and storing data and images could include the use of a primary, secondary, tertiary, or off-line storage device, an internal or third-party server, or a cloud-based storage system. In both cases, un-contemplated technology could also fulfill these functions as these are rapidly evolving areas.

According to another aspect of the apparatus for a virtual tour 100, the apparatus further comprises a reader for 2D and 3D codes 128 such as bar codes 129 and Q codes 130 for controlling access to the virtual tour. According to another aspect of the apparatus for a virtual tour 100, at least one of a brand name 131 and a logo symbol 132 are visible on the electronic device display during the virtual tour.

In another embodiment of the apparatus for a virtual tour 100, the apparatus further comprises an alarm module 133, that includes a user interface 134 for the user to enter one or more boundaries 135 on an element data value 136, and an alarm signal 137, wherein the alarm signal is at least one of a sound and an image 138 present on the electronic device when the element data value deviates 139 from user-determined boundaries 140 on the element data value 141.

According to another aspect of the apparatus for a virtual tour 100, the apparatus further comprises a maintenance scheduling module 142, that includes a user interface 134 for the user to enter at least one scheduled maintenance time 143 for at least one element 111, and a maintenance signal 144, wherein the maintenance signal is at least one of a sound and an image 145 present on the electronic device when the current time indicated on the electronic device matches the scheduled maintenance time for an element 146. In other certain aspects, the apparatus for a virtual tour 100 may further include a registration module 147, comprising a user interface 134 for the user to enter identification information 148 in a database and be designated as at least one of a registered user 149 and administrator 150, and an access control module 151, for varying each registered user's access 152 to images and data on the electronic device 153, wherein access for each registered user can be adjusted by one or more administrators 154.

In other certain aspects, the apparatus for a virtual tour 100 may further include an electric grid capacity module 155, comprising data about the current electric grid capacity in a site location 156, a user interface 134 for the user to set one or more boundaries 157 on the current electric grid capacity in the site location 156, and an electric grid capacity signal 158, wherein the electric grid capacity signal is at least one of a sound and an image present on the electronic device when the value of the current electric grid capacity in the location deviates from the user-determined boundaries on the current electric grid capacity in the location 159.

In other certain aspects, the apparatus for a virtual tour 100 may further include an electricity price spike module 160, comprising data about the current electricity price for the site location 161, a user interface 134 for the user to set one or more boundaries on the current electricity price for the site location 162, and an electricity price signal 163, wherein the electricity price signal is at least one of a sound and an image present on the electronic device when the current electricity price for the location deviates from the user-determined boundaries on the current electricity price for the location 164.

According to another aspect of the apparatus for a virtual tour 100, the element data 111 in the searchable database 106 is associated with available Leadership in Energy and Environmental Design (LEED) green building data 165 for a corresponding data element. According to another aspect of the previous embodiments, the searchable database 106 further comprises one or more reports 166 associated with one or more elements in a site location that includes corresponding Leadership in Energy and Environmental Design (LEED) green building data 165 and LEED extended information 167.

According to another aspect of the apparatus for a virtual tour 100, the apparatus includes a red target as a visible red spot 168 on the electronic device display 118, wherein the electronic device display 118 can be touched at or very near to a red target 168 to make an element image appear closer on the electronic device 118. In certain aspects, the viewing module 101 changes the image displayed on the electronic device in response to a user's physical location 169, wherein the user's physical location 169 is determined using a global positioning system (GPS) 170 or Google Earth-linked functions 171. In various aspects, the user's location may be a pre-selected virtual location 172 in the site location 156. In other various aspects, the site location 156 may be a site other than the site location where the user is located 173.

According to another aspect of the apparatus for a virtual tour 100, an internal gyroscope 174 within the electronic device 105 senses changes in the position of the electronic device 105, and causes changes in the element images displayed on the electronic device 105 in response to these changes in position of the electronic device 106. According to another aspect of the apparatus for a virtual tour 100, the user interface 134 is a building tour interface 175 for one or more users to access one or more building information management database repositories 176 utilizing a digital computing device 177. According to another aspect of the apparatus for a virtual tour, the digital computing device 177 is an iPad® tablet computing device 178. According to another aspect of the apparatus for a virtual tour, the apparatus further comprises a regulatory module 178, wherein the regulatory module 178 allows the user 179 or a third-party 180 to associate the element data 181 in the searchable database 106 with updated regulatory data 181 for a corresponding element 182 in the corresponding location 183. According to another aspect of the apparatus for a virtual tour 100, the updated regulatory data 181 is updated building code data 184 for a corresponding element 182 in the corresponding location 183.

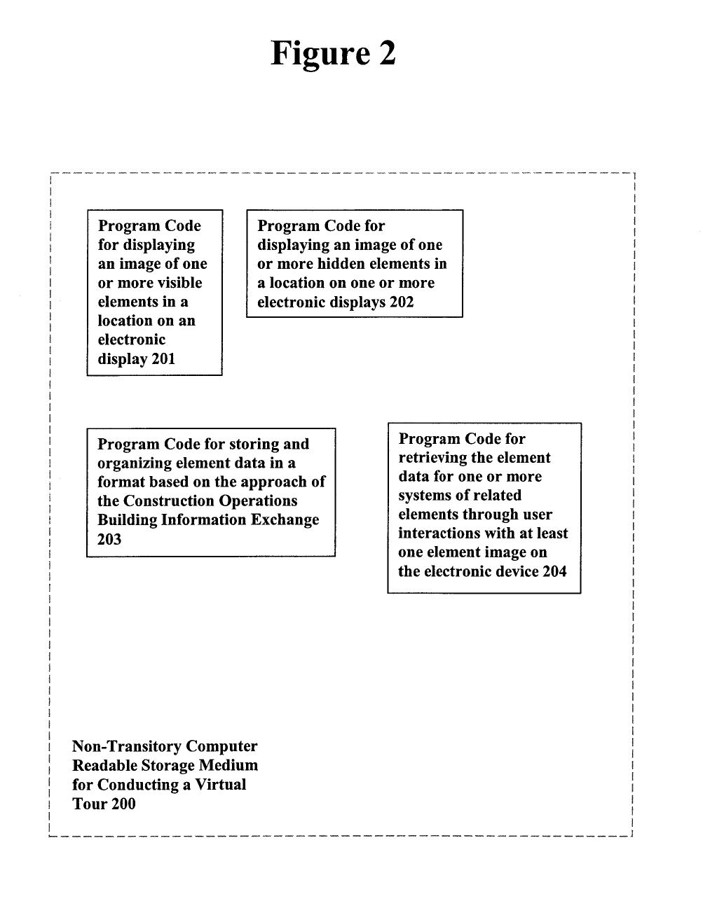

According to another embodiment, as shown in FIG. 2, a non-transitory computer-usable readable storage medium for conducting a virtual tour 200 comprises program code for displaying an image of one or more visible elements in a location on an electronic displays 201, program code for displaying an image of one or more hidden elements in a location on one or more electronic displays 202, program code for storing and organizing element data in a format based on the approach of the Construction Operations Building Information Exchange 203, and program code for retrieving the element data for one or more systems of related elements through user interactions with at least one element image on the electronic device 204.

According to one aspect of the non-transitory computer-usable readable storage medium for conducting a virtual tour 200, the non-transitory computer-usable readable storage medium for conducting a virtual tour 200 further comprises: program code for associating one or more source data elements with one or more related target data elements from the data repository 205; program code for accessing building information status data in real time via one or more peripheral input devices and one or more display devices 206; program code for linking one or more integration applications to the searchable, relational database with one or more associated databases, wherein the one or more associated databases comprise one or more disparate protocol and one or more disparate domains 207; program code for associating a virtual tour with a virtual building browser comprising a cloud-based software network application 208; program code for interfacing the virtual tour with an iPad electronic device and an iPad iOS operating system 209; program code for populating one or more operation and maintenance manuals into a building information data repository associated with the one or more searchable, relational databases and one or more physical asset elements 210; program code for tracking a user's movement in a facility where the user is located 211; and program code for activating a virtual touring application to render the touring application functional 212.

According to one aspect of the non-transitory computer-usable readable storage medium for conducting a virtual tour 200, the program code for tracking a user's movement in a facility allows for viewing a facility virtual tour by a user who is not physically present in the facility being viewed 213.

According to another aspect of the non-transitory computer-usable readable storage medium for conducting a virtual tour 200, the non-transitory computer-usable readable storage medium for conducting a virtual tour 200 further comprises program code for providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets; program code for viewing on or more hidden elements 214; program code for providing a three dimensional building information model 215; program code for providing a video tour model 216; and program code for associating photography software application with the video tour model to render one or more visible and one or more hidden elements of the facility virtual tour and a related building information model 217.

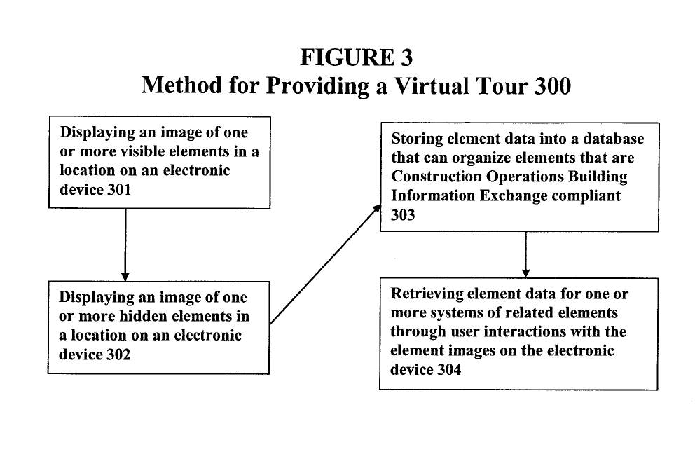

According to another embodiment, as shown in FIG. 3, a method for providing a virtual tour 300 comprises displaying an image of one or more visible elements in a location on an electronic device 301, displaying an image of one or more hidden elements in a location on an electronic device 302, storing element data into a database that can organize elements that are Construction Operations Building Information Exchange compliant 303, and retrieving element data for one or more systems of related elements through user interactions with the element images on the electronic device 304.

In other certain aspects, the method for providing a virtual tour 300, further comprises associating one or more source data elements with one or more related target data elements from the data repository 305, accessing building information status data in real time via one or more peripheral input devices and one or more display devices 306, and linking one or more integration applications to the searchable, relational database with one or more associated databases, wherein the one or more associated databases comprise one or more disparate protocol and one or more disparate domains 307. According to another aspect of the method for providing a virtual tour 300, the method further comprises associating a virtual tour with a virtual building browser comprising a cloud-based software network application 308, interfacing the virtual tour with an iPad electronic device and an iPad iOS operating system 309, populating one or more operation and maintenance manuals into a building information data repository associated with the one or more searchable, relational databases 310 and one or more physical asset elements 311, tracking a user's movement in a facility where the user is located 312, and activating a virtual touring application to render the touring application functional 313. According to another aspect of the method for providing a virtual tour 300, the method further includes steps for providing a virtual tour tracking a user's movement in a facility 314 that allows for viewing a facility virtual tour by a user who is not physically present in the facility being viewed 315. According to another aspect of the method for providing a virtual tour 300, the method further comprises providing an operating mode for touring while physically located within a facility with physical asset elements 316 associated with the one or more searchable, relational databases and that includes a selected point of reference location to subsequently create a facility profile, wherein said operating mode is selected from the group consisting of a manual mode, auto-locate mode, and a GPS mode 317.

According to another aspect of the method for providing a virtual tour 300, in the method for providing a virtual tour 300, the manual mode 318 includes a manually selected point of reference location 319. In other certain aspects, the method for providing a virtual tour 300, the auto-locate feature determines the facility location of one or more pre-identified, recognized facility assets 320. According to another aspect of the previous embodiments, in the method for providing a virtual tour 300, the global positioning system (GPS) mode further includes a GPS device integrated with the iPad iOS operating system 321. According to another aspect of the previous embodiments, the method for providing a virtual tour 300, further comprises providing a hotspot indicator for associating one or more facility assets with one or more database elements 322, wherein the hotspot indicator may be configured to open a separate dialog box to render extended information related to the associated one or more database elements with the corresponding one or more facility assets in one or more physical locations substantially adjacent to the corresponding one or more facility assets 323. According to another aspect of the previous embodiments, the method for providing a virtual tour 300 further comprises viewing one or more hidden elements 324. According to another aspect of the previous embodiments, the method for providing a virtual tour 300 further comprises providing a three dimensional building information model 325. According to another aspect of the previous embodiments, the method for providing a virtual tour further 300 further comprises providing a video tour model 326, and associating photography software application with the video tour model 327, and rendering one or more visible and one or more hidden elements of the facility virtual tour and a related building information model 328.

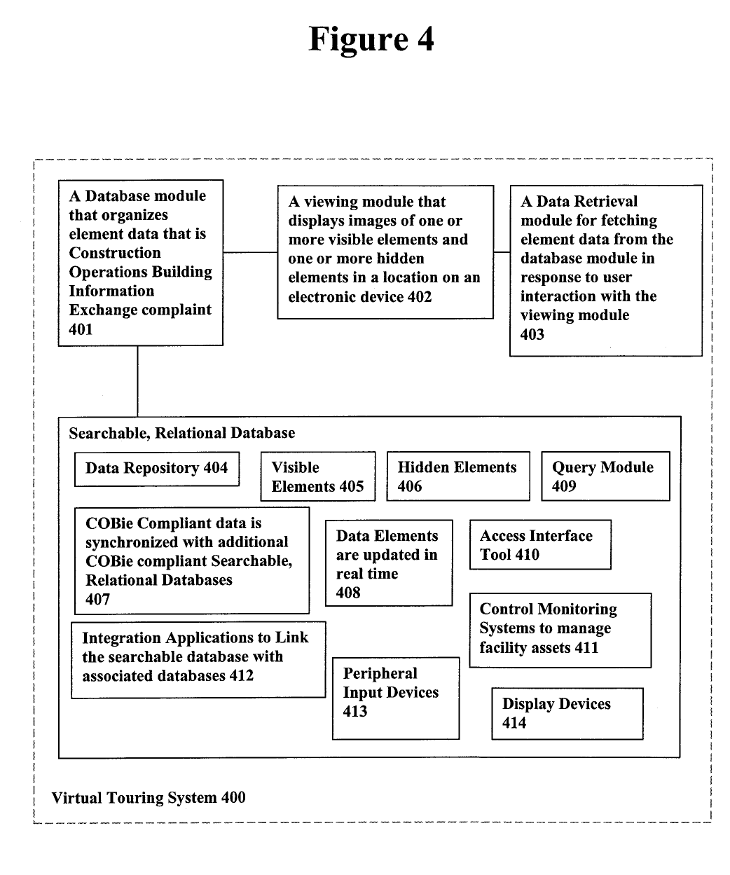

According to another embodiment, as shown in FIG. 4, a virtual touring system 400 comprises a database module 401 that organizes element data that is Construction Operations Building Information Exchange (COBie) compliant, a viewing module 402 that displays images of one or more visible elements and one or more hidden elements in a location on an electronic device, and a data retrieval module 403 for fetching element data from the database module in response to user interaction with the viewing module. According to another aspect of the virtual touring system 400, the system further comprises: a searchable, relational database comprising a data repository 404, one or more visible elements 405 and one or more hidden elements 406, wherein said searchable, relational database is configured in a COBie compliant format wherein the COBie compliant data is synchronized with one or more additional COBie compliant searchable, relational databases 407 and wherein one or more data elements are updated in real time 408; a query module wherein one or more data elements are associated with one or more related data elements from the data repository 409; an access interface tool for retrieving and updating building information status data in real-time 410; one or more control monitoring systems of maintenance, repair, and operation data to manage facility assets 411; one or more integration applications to link the searchable database with one or more associated databases 412; one or more peripheral input devices 413; and one or more display devices 414.

According to another aspect of the previous embodiments, the virtual touring system 400 further comprises a cloud-based software network application 415. According to another aspect of the previous embodiments, in the virtual touring system 400 the access interface tool for retrieving and updating building information status data in real-time is an asset management tool 416. According to another aspect of the previous embodiments, in the virtual touring system 400 the viewing module that displays an image of at least one of a visible element and one of a hidden element in a first location on an electronic device is a touring application 417.

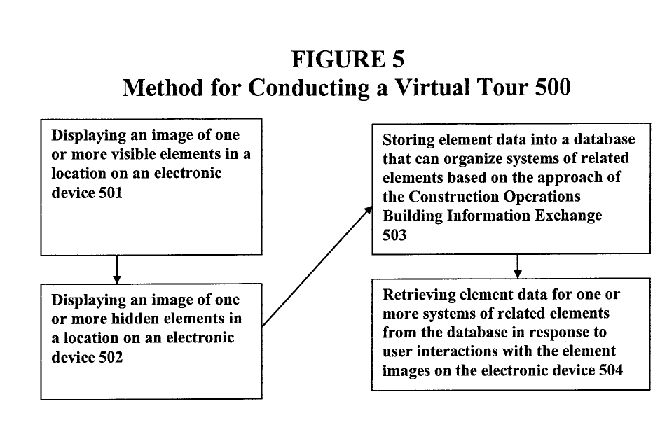

According to another embodiment, as shown in FIG. 5, one or more processor-readable storage devices having processor readable code embodied on at least one processor readable storage device, said processor readable code causes at least one processor readable storage device to perform a method of conducting a virtual tour 500 comprising steps for displaying an image of one or more visible elements in a location on an electronic device 501, displaying an image of one or more hidden elements in a location on an electronic device 502, storing element data into a database that can organize systems of related elements based on the approach of the Construction Operations Building Information Exchange (COBie) 503, and retrieving element data for one or more systems of related elements from the database in response to user interactions with the element images on the electronic device 504.

According to another aspect of the previous embodiment, said processor readable code causes at least one processor readable storage device to perform a method of conducting a virtual tour 500, further comprises steps for associating one or more source data elements with one or more related target data elements from the data repository 505, accessing building information status data in real time via one or more peripheral input devices and one or more display devices 506, and linking one or more integration applications to the searchable, relational database with one or more associated databases, wherein the one or more associated databases comprise one or more disparate protocol and one or more disparate domains 507. According to another aspect of the previous embodiments, said processor readable code causes at least one processor readable storage device to perform a method of conducting a virtual tour 500, further comprising steps for associating a virtual tour with a virtual building browser 508 that includes a cloud-based software network application 509, interfacing the virtual tour with an iPad electronic device and an iPad iOS operating system 510, populating one or more operation and maintenance manuals into a building information data repository associated with the one or more searchable, relational databases and one or more physical asset elements 511, tracking a user's movement in a facility where the user is located 512, and activating a virtual touring application to render the touring application functional 513. According to another aspect of the previous embodiments, said processor readable code causes at least one processor readable storage device to perform a method of conducting a virtual tour 500, further comprising steps for providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets 514; providing an iPad electronic tablet device integrated with the iPad iOS operating system 515; viewing one or more hidden elements 516; providing a three dimensional building information model 517; providing a video tour model 518; and associating photography software application with the video tour model to render one or more visible and one or more hidden elements of the facility virtual tour and a related building information model 519.

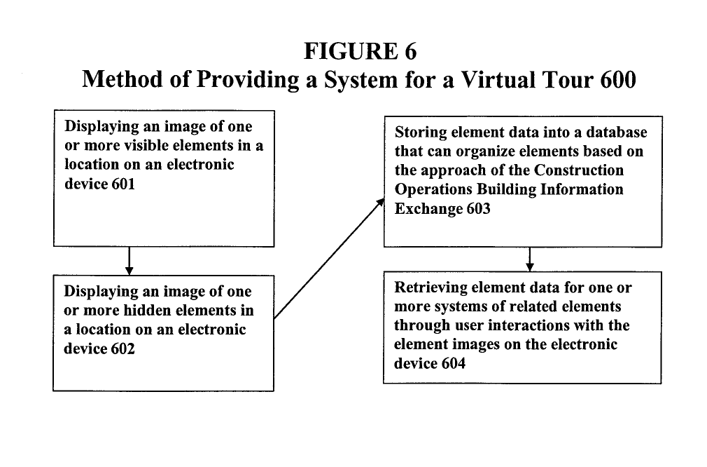

According to another embodiment, illustrated in FIG. 6, a computer-implemented method includes computer-usable readable storage medium having computer-readable program code embodied therein for causing a computer system to perform a method of providing a system for a virtual tour 600 comprising steps for displaying an image of one or more visible elements in a location on an electronic device 601; displaying an image of one or more hidden elements in a location on an electronic device 602; storing element data into a database that can organize elements based on the approach of the Construction Operations Building Information Exchange (COBie) 603; and retrieving element data for one or more systems of related elements through user interactions with the element images on the electronic device 604.

According to an aspect of the previous embodiment, the computer-implemented method that includes computer-usable readable storage medium having computer-readable program code embodied therein for causing a computer system to perform a method of providing a system for a virtual tour 600 further comprises steps for associating one or more source data elements with one or more related target data elements from the data repository 605, accessing building information status data in real time via one or more peripheral input devices and one or more display devices 606, and linking one or more integration applications to the searchable, relational database with one or more associated databases, wherein the one or more associated databases comprise one or more disparate protocol and one or more disparate domains 607. According to another aspect of the previous embodiment, the computer-implemented method that includes computer-usable readable storage medium having computer-readable program code embodied therein for causing a computer system to perform a method of providing a system for a virtual tour 600 further comprises steps for associating a virtual tour with a virtual building browser comprising a cloud-based software network application 608, interfacing the virtual tour with an iPad electronic device and an iPad iOS operating system 609, populating one or more operation and maintenance manuals into a building information data repository associated with the one or more searchable, relational databases and one or more physical asset elements 610, tracking a user's movement in a facility where the user is located 611, and activating a virtual touring application to render the touring application functional 612.

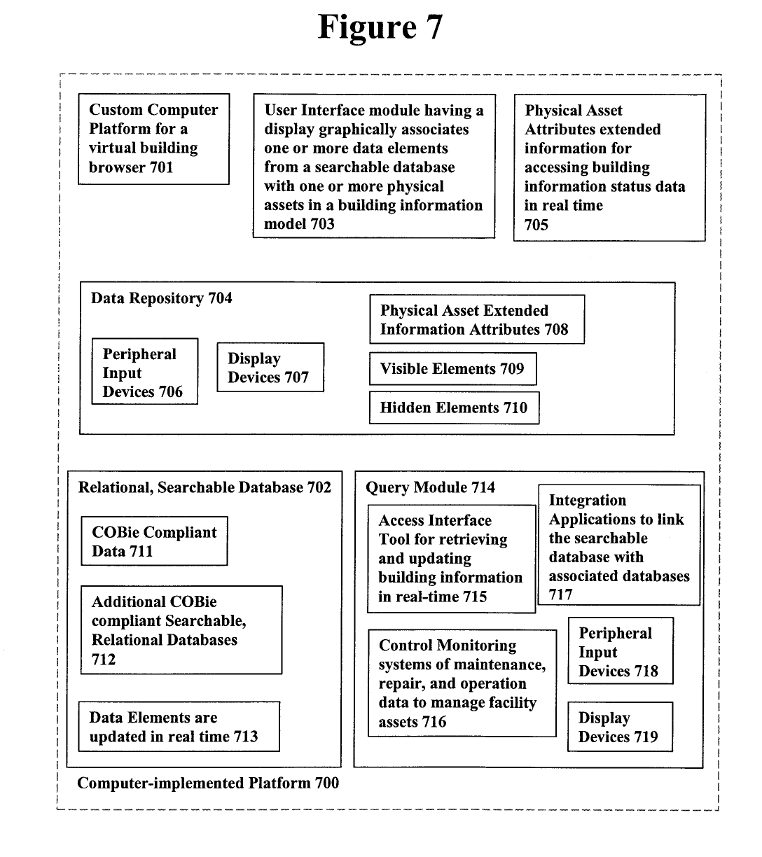

According to another embodiment, illustrated in FIG. 7, a computer-implemented platform 700 including a non-transitory computer-usable readable storage medium having non-transitory computer-readable program codes embodied therein for causing a computer system to provide steps for a virtual tour system comprises a custom computer platform for a virtual building browser 701, a user interface module having a display 702, wherein the display graphically associates one or more data elements from a relational, searchable database 703 with one or more physical assets in a building information model, the relational, searchable database 703 for storing element data in a data repository 704 comprising one or more physical asset attributes extended information for accessing building information status data in real time 705 via one or more peripheral input devices 706 and one or more display devices 707 wherein the data repository 704 associates one or more physical asset extended information attributes 708 to one or more visible elements 709 and one or more hidden elements 710, and wherein said searchable, relational database 706 is configured in a Construction Operations Building Information Exchange (COBie) compliant format that includes COBie compliant data 711, and wherein the COBie compliant data is synchronized with one or more additional COBie compliant searchable, relational databases 712 and wherein one or more data elements are updated in real time 713, a query module 714 wherein one or more data elements are associated with one or more related data elements from the data repository, an access interface tool for retrieving and updating building information status data in real-time 715, one or more control monitoring systems of maintenance, repair, and operation data to manage facility assets 716, one or more integration applications to link the searchable database with one or more associated databases 717, one or more peripheral input devices 718, and one or more display devices 719.

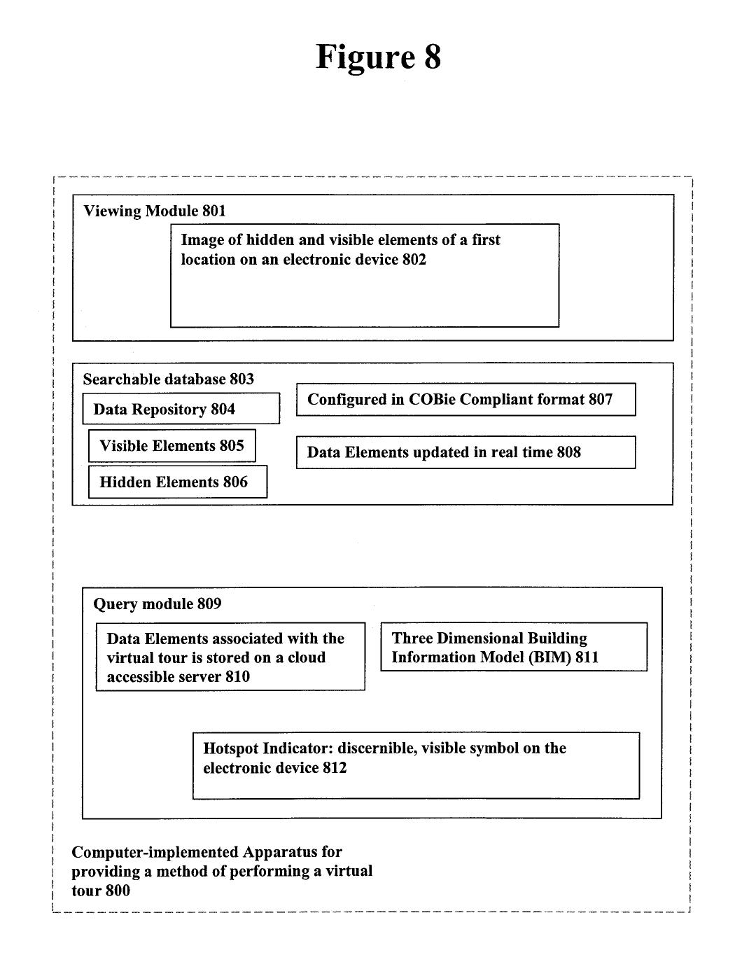

According to another embodiment, shown in FIG. 8, a computer-implemented apparatus for providing a method of performing a virtual tour 800, said apparatus comprises a viewing module 801 that displays an image of at least one of a visible element and one of a hidden element in a first location on an electronic device 802, a searchable database 803 comprising a data repository 804, one or more visible elements 805 and one or more hidden elements 806, wherein said searchable database is configured in a Construction Operations Building Information Exchange (COBie) compliant format 807 and wherein one or more data elements are updated in real time 808, and a query module wherein one or more data elements are associated with one or more related data elements from the data repository 809, wherein at least one or more data elements associated with the virtual tour is stored on a cloud-accessible server 810, and wherein the viewing module includes a three dimensional building information model (BIM) 811 that further comprises images of visible and hidden elements wherein the viewing module indicates an element image associated with one or more data elements by displaying a hotspot indicator 812 near the element image, wherein the hotspot indicator is a discernible, visible symbol on the electronic device.

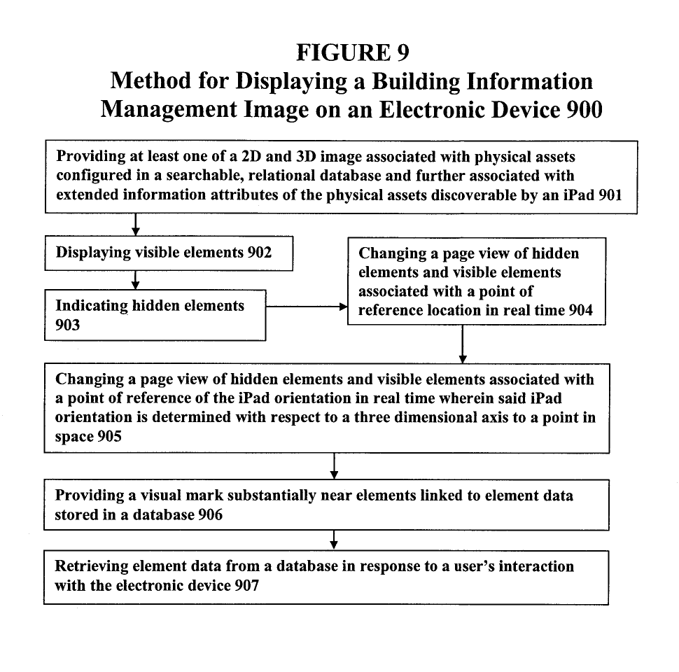

According to another embodiment, shown in FIG. 9, a method for displaying a building information management image of a location on an electronic device 900 comprises: providing at least one of a 2D and 3D image associated with one or more physical assets configured in a searchable, relational database and further associated with extended information attributes of the one or more physical assets discoverable by an iPad electronic tablet device integrated with an iPad iOS operating system 901; displaying visible elements 902; indicating hidden elements 903; changing a page view of said hidden elements and said visible elements associated with a point of reference location in real time 904; changing a page view of said hidden elements and said visible elements associated with a point of reference of the iPad electronic tablet device orientation in real time wherein said iPad electronic tablet device orientation is determined with respect to a three dimensional axis to a point in space 905; providing a visual mark substantially near one or more elements linked to element data stored in a database 906; and retrieving element data from a database in response to a user's interaction with the electronic device 907. According to another aspect of the previous embodiment, the method for displaying a building information management image of a location on an electronic device, the point of reference location is a user physical location 908. According to another aspect of the previous embodiments, in the method for displaying a building information management image of a location on an electronic device, the point of reference location is a user virtual location 909. According to another aspect of the previous embodiments, in the method for displaying a building information management image of a location on an electronic device the point of reference location is a user virtual location determined by a GPS embedded software application 910.

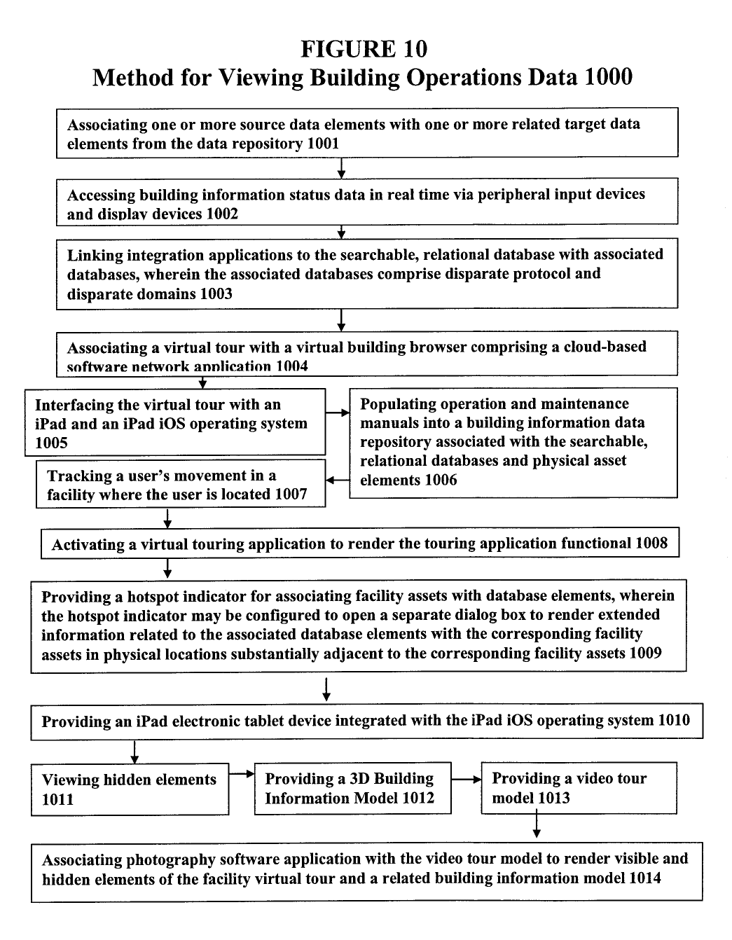

According to another embodiment, depicted in FIG. 10, a method for viewing building operations data 1000 comprises: associating one or more source data elements with one or more related target data elements from the data repository 1001; accessing building information status data in real time via one or more peripheral input devices and one or more display devices 1002; linking one or more integration applications to the searchable, relational database with one or more associated databases, wherein the one or more associated databases comprise one or more disparate protocol and one or more disparate domains 1003; associating a virtual tour with a virtual building browser comprising a cloud-based software network application 1004; interfacing the virtual tour with an iPad electronic device and an iPad iOS operating system 1005; populating one or more operation and maintenance manuals into a building information data repository associated with the one or more searchable, relational databases and one or more physical asset elements 1006; tracking a user's movement in a facility where the user is located 1007; activating a virtual touring application to render the touring application functional 1008; providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets 1009; providing an iPad electronic tablet device integrated with the iPad iOS operating system 1010; viewing one or more hidden elements 1011; providing a three dimensional building information model 1012; providing a video tour model 1013; and associating a photography software application with the video tour model to render one or more visible and one or more hidden elements, of the facility virtual tour and a related building information model 1014.

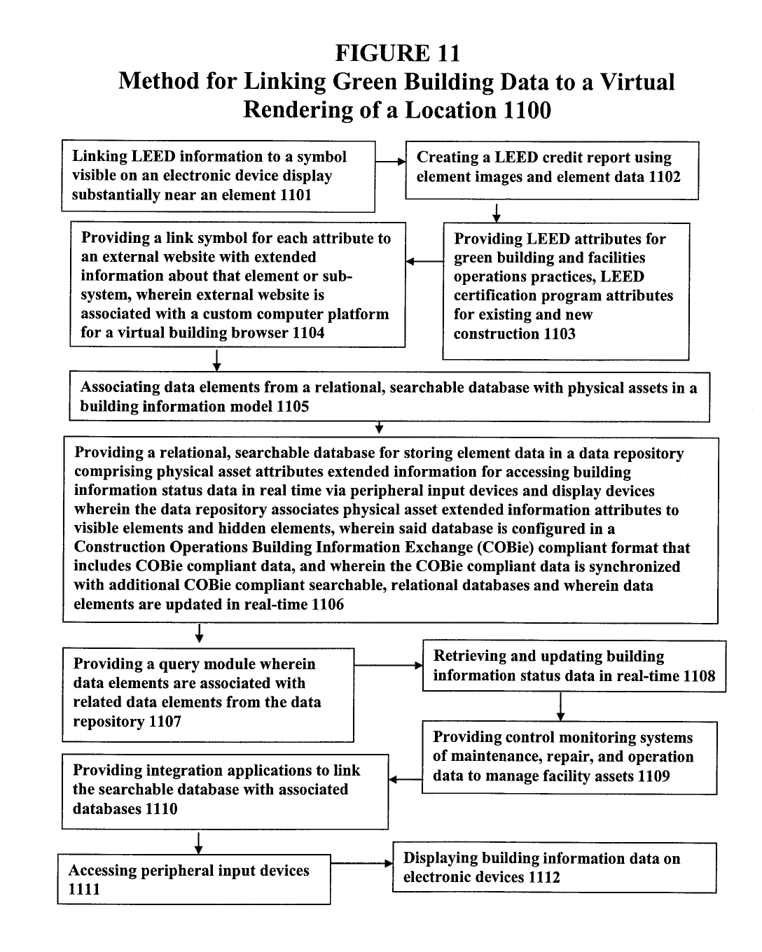

According to another embodiment, illustrated in FIG. 11, a method for linking green building data to a virtual rendering of a location 1100 comprises: linking Leadership in Energy and Environmental Design (LEED) information to a symbol visible on an electronic device display substantially near an element 1101; creating a LEED credit report using element images and element data 1102; providing one or more LEED attributes for green building and facilities operations practices, one or more LEED certification program attributes for existing and new construction 1103; providing a link symbol for each one or more attribute, to an external website with extended information about that element or sub-system, wherein said external website is associated with a custom computer platform for a virtual building browser 1104; associating one or more data elements from a relational, searchable database with one or more physical assets in a building information model 1105; providing a relational, searchable database for storing element data in a data repository comprising one or more physical asset attributes and extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements, are updated in real time 1106; providing a query module wherein one or more data elements, are associated with one or more related data elements from the data repository 1107; retrieving and updating building information status data in real-time 1108; providing one or more control monitoring systems of maintenance, repair, and operation data to manage facility assets 1109; providing one or more integration applications to link the searchable database with one or more associated databases 1110; accessing one or more peripheral input devices 1111; and displaying building information data on one or more electronic devices 1112.

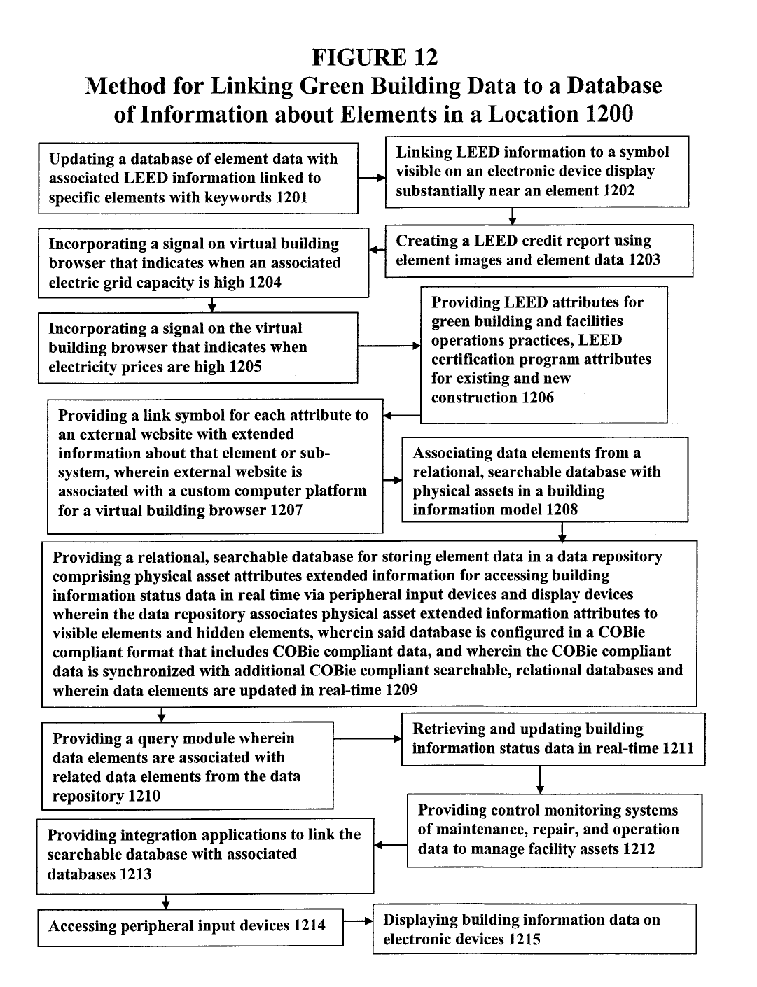

According to another embodiment, as depicted in FIG. 12, a method for linking green building data to a database of information about elements in a location 1200 comprises: updating a database of element data with associated LEED information linked to specific elements with keywords 1201; linking LEED information to the element data stored on the database 1202; creating a LEED credit report using visual images and data stored in the database 1203; incorporating a signal on virtual building browser that indicates when an associated electric grid capacity is high 1204; incorporating a signal on the virtual building browser that indicates when electricity prices are high 1205; providing one or more Leadership in Energy and Environmental Design attributes for green building and facilities operations practices, one or more LEED certification program attributes for existing and new construction 1206; providing a link symbol for each one or more attribute to an external website with extended information about that element or sub-system, wherein said external website is associated with a custom computer platform for a virtual building browser 1207; associating one or more data elements from a relational, searchable database with one or more physical assets in a building information model 1208; providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time 1209; providing a query module wherein one or more data elements are associated with one or more related data elements from the data repository 1210; retrieving and updating building information status data in real-time 1211; providing one or more control monitoring systems of maintenance, repair, and operation data to manage facility assets 1212; providing one or more integration applications to link the searchable database with one or more associated databases 1213; accessing one or more peripheral input devices 1214; and displaying building information data on one or more electronic devices 1215.

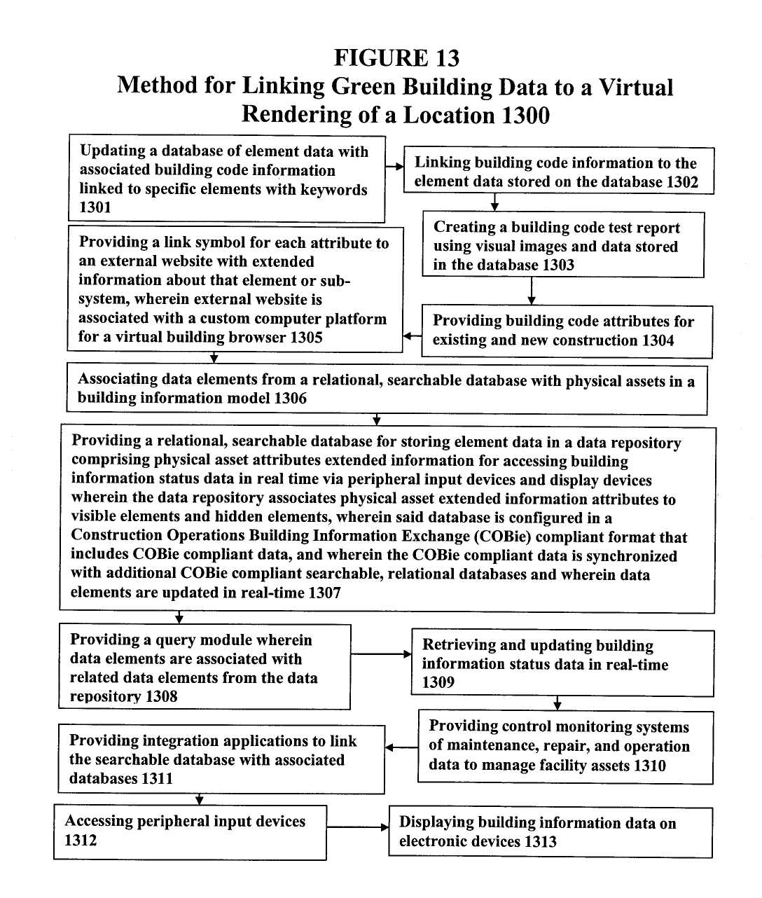

According to another embodiment, as shown in FIG. 13, a method for linking a virtual touring device to regulatory data about elements in a location 1300 comprises: updating a database of element data with associated building code information linked to specific elements with keywords 1301; linking building code information to the element data stored on the database 1302; creating a building code test report using visual images and data stored in the database 1303; providing one or more building code attributes for existing and new construction 1304; providing a link symbol for each one or more attribute to an external website with extended information about that element or sub-system, wherein said external website is associated with a custom computer platform for a virtual building browser 1305; associating one or more data elements from a relational, searchable database with one or more physical assets in a building information model 1306; providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time 1307; providing a query module wherein one or more data elements are associated with one or more related data elements from the data repository 1308; retrieving and updating building information status data in real-time 1309; providing one or more control monitoring systems of maintenance, repair, and operation data to manage facility assets 1310; providing one or more integration applications to link the searchable database with one or more associated databases 1311; accessing one or more peripheral input devices 1312; and displaying building information data on one or more electronic devices 1313.

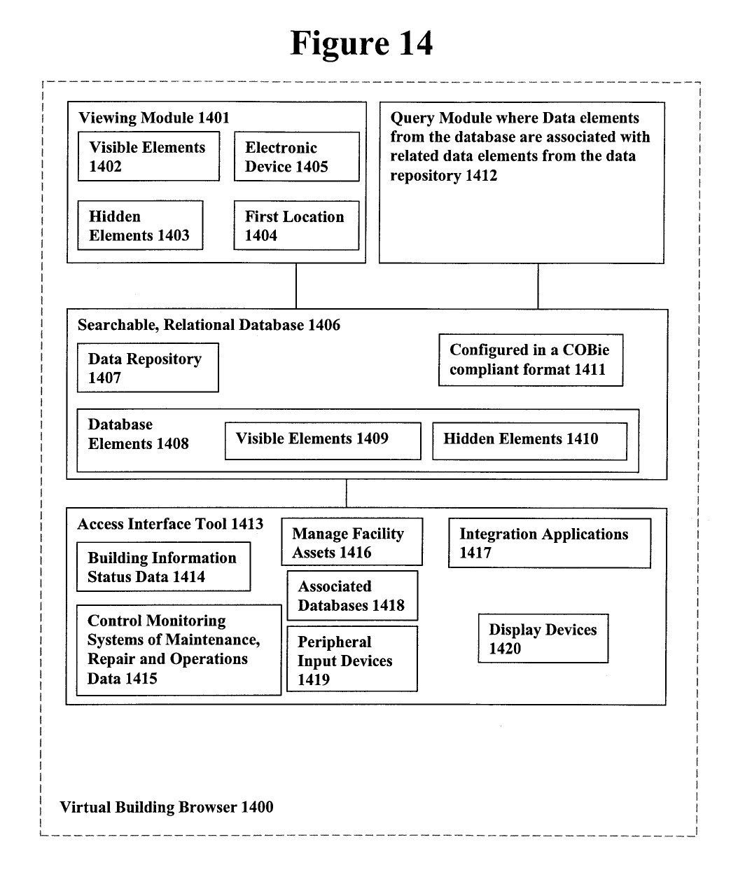

According to another embodiment, as illustrated in FIG. 14, a virtual building browser 1400 comprises a viewing module 1401 that displays an image of at least one of a visible element 1402 and one of a hidden element 1403 in a first location 1404 on an electronic device 1405; a searchable, relational database 1406 comprising a data repository 1407, database elements 1408 corresponding to one or more visible elements 1409 and one or more hidden elements 1410, wherein said searchable database 1406 is configured in a Construction Operations Building Information Exchange compliant format 1411 and wherein one or more database elements 1408 are updated in real time; a query module 1412 wherein one or more database elements 1411 are associated with one or more related database elements 1412 from the data repository 1407; an access interface tool 1413 for retrieving and updating building information status data 1414 in real-time; one or more control monitoring systems of maintenance, repair, and operation data 1415 to manage facility assets 1416; one or more integration applications 1417 to link the searchable database 1406 with one or more associated databases 1418; one or more peripheral input devices 1419; and one or more display devices 1420.

According to other aspects of the virtual building browser 1400, the virtual building browser 1400 is associated with a cloud-based software network application 1421. According to another aspect of the virtual building browser 1400, the access interface tool 1413 for retrieving and updating building information status data 1414 in real-time is an asset management tool 1422. According to another aspect of the virtual building browser 1400, the asset management tool 1422 populates one or more searchable operation and maintenance manuals 1423 into the data repository 1407 during the design and construction process.

According to another aspect of the virtual building browser 1400, the viewing module 1401 that displays an image of at least one of a visible element 1402 and one of a hidden element 1403 in a first location 1404 on an electronic device 1405, is a touring application 1424. According to another aspect of the virtual building browser 1400, the virtual building browser 1400 includes an iPad iOS operating system interface 1425; an operating mode 1426, located in a facility wherein the user is located and 1428 that is used for tracking a user's movement 1427, includes a selected point of reference location 1429 and a subsequently tracked user's facility movement profile 1430; and an activation selector 1431 that is in the open position 1432 to render the touring application functional.

According to another aspect of the virtual building browser 1400, the operating mode 1426 is one of either a manual mode 1433 that includes a manually selected point of reference location 1434 or an auto-locate feature 1435 that determines the facility location 1436 of one or more pre-identified, recognized facility assets 1416. According to another aspect of the virtual building browser 1400, the virtual building browser 1400 includes a GPS mode 1436 for tracking a user's movement 1427 in a facility wherein the user is located 1428 by a GPS device 1437 integrated with the iPad iOS operating system 1425, the auto-locate feature 1435 and the manual mode 1433 described above.

In other certain aspects, the virtual building browser 1400 displays a hotspot indicator 1438 to associate one or more facility assets 1416 with one or more database elements 1408, wherein the hotspot indicator 1438 may be configured to open a separate dialog box 1439 to render extended information 1440 related to the associated one or more database elements 1408, with the corresponding one or more facility assets 1416 in a physical location 1441 substantially adjacent to the corresponding one or more facility assets 1416.

In another aspect of the virtual building browser 1400, a user located in the facility in a stationary position 1442 can view at least one of a visible element 1402 and one of a hidden element 1403. In other certain aspects, the virtual building browser 1400 further comprises a three dimensional building information model (BIM) 1443. In other certain aspects, the virtual building browser 1400 further comprises a video tour model 1444.

According to another aspect of the previous embodiments, a virtual building browser 1400 further comprises a photography software application 1449 associated with the video tour model 1444 to render one or more visible and one or more hidden elements 1402, 1403, thereby making them viewable elements 1445, and wherein the photography software application 1449 integrates to one or more of the database elements 1408 to associate the viewable elements 1445 in the video tour model 1444 with associated extended information 1450 about one or more visible and the one or more hidden elements 1402, 1403. In certain other aspects of the previous embodiments, the virtual building browser 1400 further comprises photography software 1450 that alternatively includes pan, tilt and zoom functions, to view live and archived data 1451, 1452 of the one or more visible and one or more hidden elements 1402, 1403 using the virtual building browser 1400 by tapping substantially adjacent to a hotspot indicator 1438.

According to another aspect of the previous embodiments, a virtual building browser 1400 further comprises a regulatory module 1453, wherein the regulatory module 1453 allows the user or a third-party to associate the database elements 1408 in the searchable database 1406 with updated regulatory data 1454 for a corresponding element 1455 in the corresponding location 1456. In certain other aspects of the virtual building browser 1400, the updated regulatory data 1454 is updated building code data 1457 for a corresponding element 1455 in the corresponding location 1456.

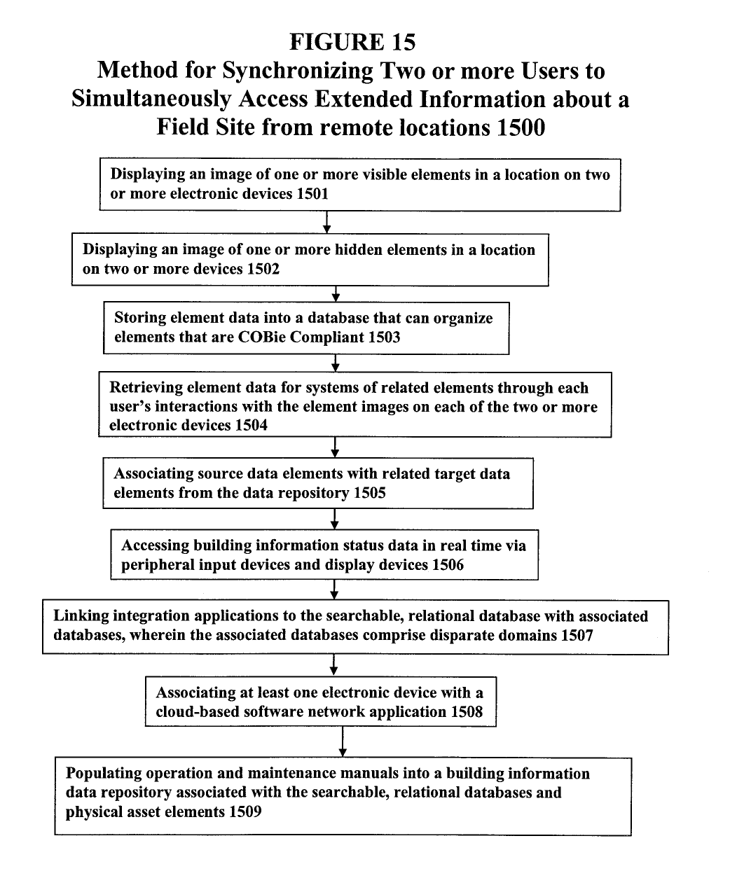

According to another embodiment, as shown in FIG. 15, a method for synchronizing two or more users, to simultaneously access extended information about a field site from one or more remote locations 1500 comprises: displaying an image of one or more visible elements in a location on two or more electronic devices 1501; displaying an image of one or more hidden elements in a location on two or more electronic devices 1502; storing element data into a searchable, relational database comprising a data repository, and element data corresponding to one or more visible elements and one or more hidden elements, wherein said searchable database is configured in a Construction Operations Building Information Exchange compliant format 1503; retrieving element data for one or more systems of related elements through each user's interactions with the images of visible and hidden elements on each of the two or more electronic devices 1504; associating one or more source data elements with one or more related target data elements from the data repository 1505; accessing building information status data in real time via one or more peripheral input devices and one or more display devices 1506; linking one or more integration applications to the searchable, relational database with one or more associated databases, wherein the one or more associated databases comprise one or more disparate protocols and one or more disparate domains 1507; and associating at least one electronic device with a cloud-based software network application 1508.

In certain other aspects of the method for synchronizing two or more users to simultaneously access extended information about a field site from one or more remote locations 1500, at least one electronic device is an iPad electronic device with an iPad iOS operating system. In another aspect of the previous embodiment 1500, one electronic device is tracking movements of a user located in a facility, allowing remote viewing of a facility by a user who is not physically present in the facility being viewed 1509.

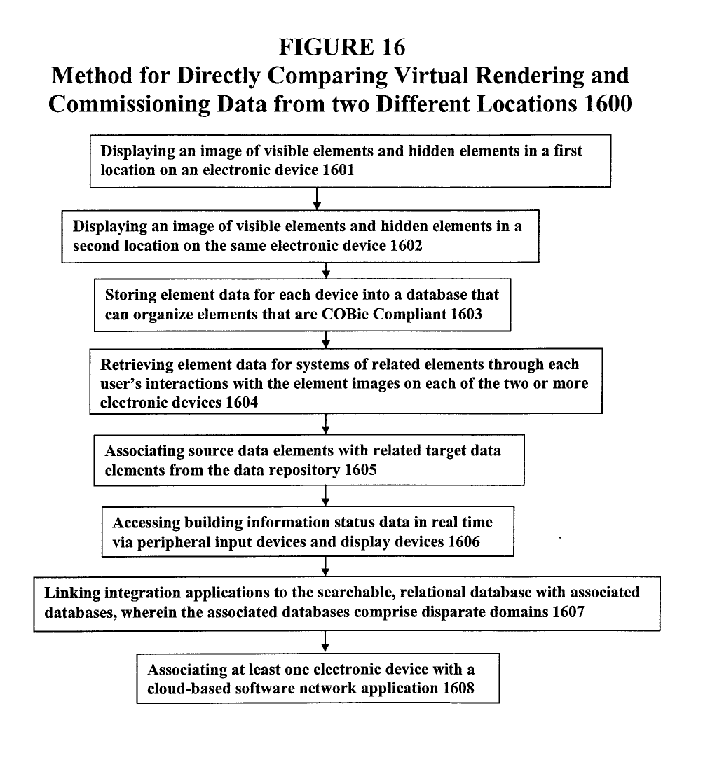

According to another embodiment, as illustrated in FIG. 16, a method for directly comparing a virtual rendering and commissioning data from two different locations 1600 comprises: displaying an image of one or more visible and hidden elements in a first location on an electronic device 1601; displaying an image of one or more visible and hidden elements in a second location on the same electronic device 1602; storing element data for each location into a searchable, relational database, comprising a data repository and element data, wherein said searchable databases is configured in a Construction Operations Building Information Exchange compliant format 1603; retrieving element data for one or more systems of related elements through a user's interactions with images of hidden and visible elements on the electronic device 1604; associating one or more source data elements with one or more related target data elements from the data repository 1605; accessing building information status data in real time via one or more peripheral input devices and one or more display devices 1606; linking one or more integration applications to the searchable, relational databases with one or more associated databases, wherein the one or more associated databases comprise one or more disparate protocols and one or more disparate domains 1607; associating the electronic device with a cloud-based software network application 1608.

In certain other aspects of the method for directly comparing a virtual rendering and commissioning data from two different locations 1600, the electronic device is an iPad electronic device with an iPad iOS operating system. In other aspects of the method for directly comparing a virtual rendering and commissioning data from two different locations 1600, the electronic device is tracking the user's movement in a facility where the user is located 1609, assigning the first location 1600 as the user's location 1610.

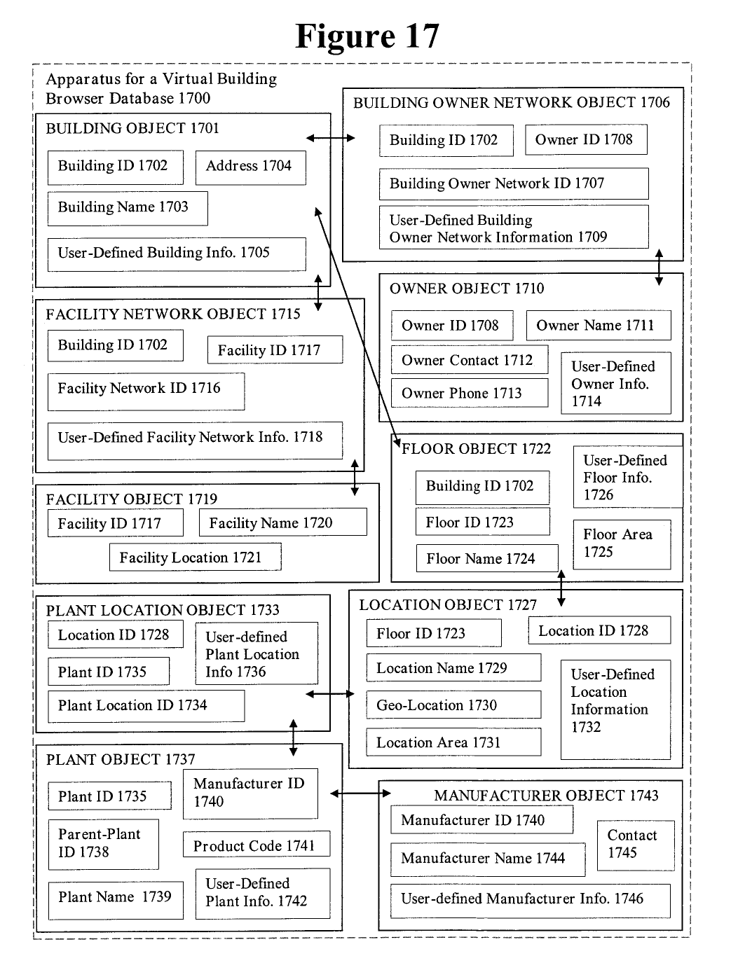

In another embodiment, as shown in FIG. 17, an apparatus for a virtual building browser database 1700, comprises a building object 1701, further comprising a building identification field 1702; a building name field 1703; one or more address fields 1704; and a user-defined building information field 1705; one or more building owner network objects 1706 corresponding to the building object 1701, each further comprising a building owner network identification field 1707; an owner identification field 1708; the building identification field 1702; and a user-defined building owner network information field 1709; an owner object 1710 corresponding to one or more building owner network objects 1706, further comprising the corresponding owner identification field 1708; one or more owner name fields 1711; one or more owner contact fields 1712; one or more owner phone fields 1713; and a user-defined owner information field 1714; a facility network object 1715 corresponding to the building object 1701, further comprising a facility network identification field 1716; a facility identification field 1717; the building identification field 1702; and a user-defined facility network information field 1718; a facility object 1719 corresponding to one or more facility network objects 1715, further comprising the corresponding facility identification field 1717; a facility name field 1720; and at least one facility location field 1721; one or more floor objects 1722 corresponding to the building object 1701, each further comprising a floor identification field 1723; the building identification field 1702; a floor name field 1724, a floor area field 1725; and a user-defined floor information field 1726; one or more location objects 1727 corresponding to a floor object 1722, each further comprising a location identification field 1728; the floor identification field 1723; a location name field 1729; a geo-location field 1730; a location area field 1731; and a user-defined location information field 1732; one or more plant location objects 1733 corresponding to a location object 1727, each further comprising a plant location identification field 1734; the location identification field 1728; a plant identification field 1735; and a user-defined plant location information field 1736; a plant object 1737 corresponding to one or more plant location objects 1733, further comprising the corresponding plant identification field 1735; a parent-plant identification field 1738; at least one plant name field 1739; a manufacturer identification field 1740; a product code field 1741; and a user-defined plant information field 1742; a manufacturer object 1743 corresponding to one or more plant objects 1737, further comprising the corresponding manufacturer identification field 1740; at least one manufacturer name field 1744; a contact field 1745; and a user-defined manufacturer information field 1746. In another aspect of the previous embodiment, the virtual building browser database is a virtual asset management system 1747.

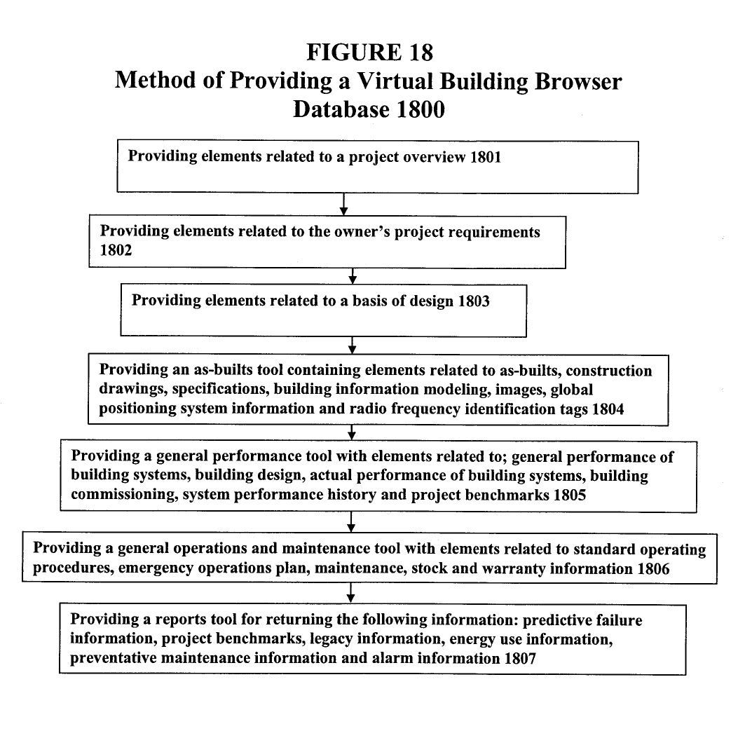

In another embodiment, as depicted in FIG. 18, a method of providing a virtual building browser database 1800 comprises; providing one or more elements related to a project overview 1801; providing one or more elements related to the owner's project requirements 1802; providing one or more elements related to a basis of design 1803; providing an as-builts tool comprising one or more elements related to as-builts, one or more elements related to construction drawings, one or more elements related to specifications, one or more elements related to building information modeling, one or more images, one or more elements related to global positioning system information, and one or more elements related to radio frequency identification tags 1804; providing a general performance tool comprising one or more elements related to general performance of building systems, one or more elements related to building design, one or more elements related to actual performance of building systems, one or more elements related to building commissioning, one or more elements related to system performance history, and one or more elements related to project benchmarks 1805; providing a general operations and maintenance tool, comprising one or more elements related to general operations and maintenance, one or more elements related to standard operating procedures, one or more elements related to an emergency operations plan, one or more elements related to maintenance, one or more elements related to stock or inventory, and one or more elements related to warranty information 1806; providing a reports tool, comprising predictive failure information, project benchmarks information, legacy information, energy use information, preventative maintenance information, and alarm information 1807. In another aspect of the previous embodiment, the virtual building browser database is a virtual asset management system.

Predictive failure information includes data from parts manufacturers about the expected lifespan of various facility asset components so that a user can estimate when a particular system or component may need to be repaired or replaced. Project benchmarks information includes data useful for comparing the relative performance and quality of the building, building systems, and building components to those of other buildings, building systems, and building components. Values that may be considered include quality, time, and cost. Legacy information includes records of previous construction work, commissioning work, and operations and maintenance work associated with a location. Energy use information includes records of energy use for different building systems over different time periods. Preventative maintenance information includes manufacturer's information about physical asset components, may include a schedule of routine maintenance work, and may include a record of maintenance work performed and to-be-performed on components. Alarm information includes information about user-selected signals that appear as sounds and/or images on an electronic device when a user-selected event occurs. Signals may include an alarm signal that appears when element data values deviate from user-determined boundaries, a maintenance signal present when the current time indicated on the electronic device matches the scheduled maintenance time for an element, an electric grid capacity signal present when the value of the current electric grid capacity in the location deviates from the user-determined boundaries on the current electric grid capacity in the location, and an electricity price signal present when the current electricity price for the location deviates from the user-determined boundaries on the current electricity price for the location. These alarms or signals appear as sounds and/or images on the electronic device that are apparent when a user-selected event occurs. Alarm information may include records of prior alarm and signal events and may include information about the user-selected conditions during which the sounds and/or images appear.

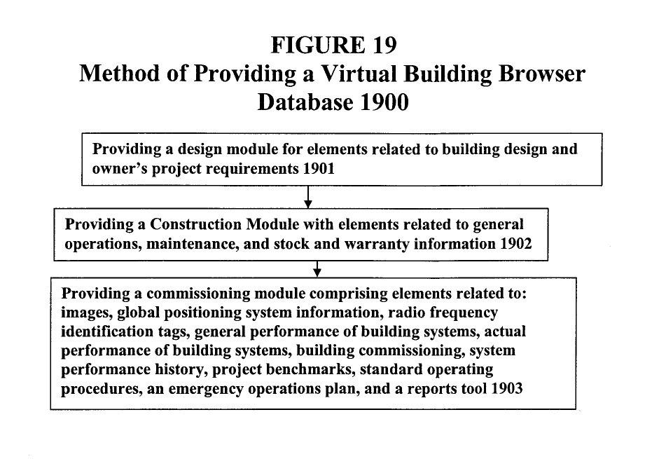

In another embodiment, as shown in FIG. 19, a method of providing a virtual building browser database 1900 comprises; providing a design module, further comprising one or more elements related to a project overview, one or more elements related to the owner's project requirements, one or more elements related to a basis of design, one or more elements related to as-builts, one or more elements related to construction drawings, one or more elements related to building design, one or more elements related to specifications, and one or more elements related to building information modeling 1901; providing a construction module, further comprising one or more elements related to general operations and maintenance, one or more elements related to maintenance one or more elements related to stock and one or more elements related to warranty information 1902; providing commissioning module, further comprising one or more images, one or more elements related to global positioning system information, one or more elements related to radio frequency identification tags, one or more elements related to general performance of building systems, one or more elements related to actual performance of building systems, one or more elements related to building commissioning, one or more elements related to system performance history, one or more elements related to project benchmarks, one or more elements related to standard operating procedures, one or more elements related to an emergency operations plan, and a reports tool 1903, further comprising predictive failure information, project benchmarks information, legacy information, energy use information, preventative maintenance information, and alarm information. In another aspect of the previous embodiment, the virtual building browser database is a virtual asset management system. Predictive failure information, project benchmarks information, legacy information, energy use information, preventative maintenance information, and alarm information are as described in [0169].

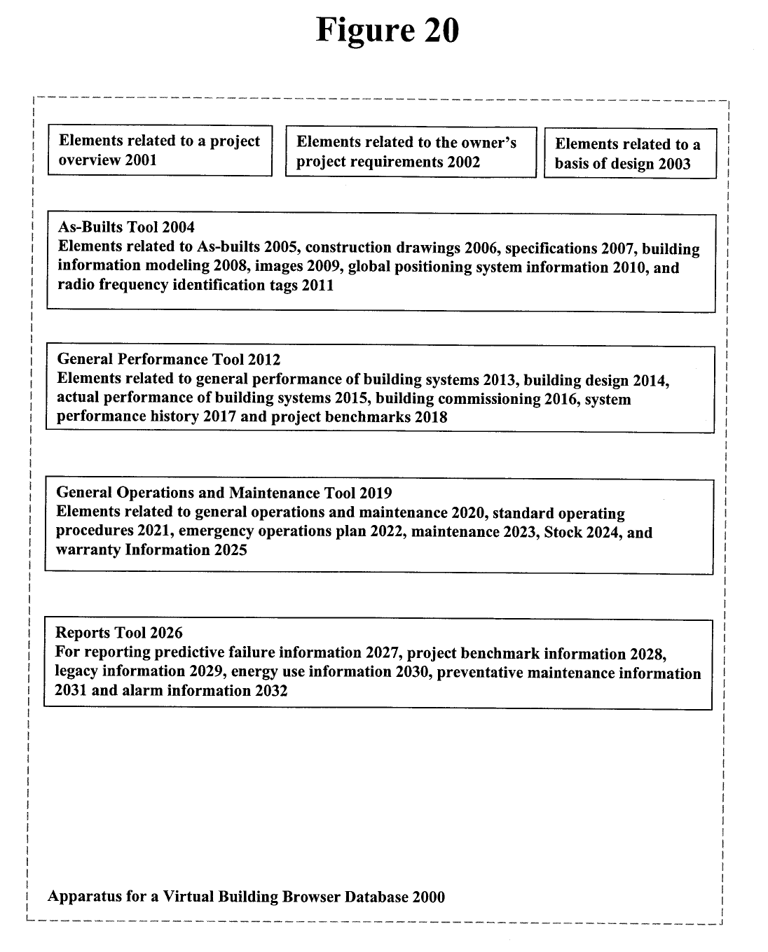

In another embodiment, as shown in FIG. 20, an apparatus for a virtual building browser database 2000 comprises: one or more elements related to a project overview 2001; one or more elements related to the owner's project requirements 2002; one or more elements related to a basis of design 2003; an as-builts tool 2004, further comprising one or more elements related to as-builts 2005, one or more elements related to construction drawings 2006, one or more elements related to specifications 2007, and one or more elements related to building information modeling 2008, one or more images 2009, one or more elements related to global positioning system information 2010, and one or more elements related to radio frequency identification tags 2011; a general performance tool 2012, further comprising one or more elements related to general performance of building systems 2013, one or more elements related to building design 2014, one or more elements related to actual performance of building systems 2015, one or more elements related to building commissioning 2016, one or more elements related to system performance history 2017, and one or more elements related to project benchmarks 2018; a general operations and maintenance tool 2019, further comprising one or more elements related to general operations and maintenance 2020, one or more elements related to standard operating procedures 2021, one or more elements related to an emergency operations plan 2022, one or more elements related to maintenance 2023, one or more elements related to stock 2024, and one or more elements related to warranty information 2025; a reports tool 2026, further comprising predictive failure information 2027, project benchmarks information 2028, legacy information 2029, energy use information 2030, preventative maintenance information 2031, and alarm information 2032. In another aspect of the previous embodiment, the virtual building browser database is a visual asset management system 2033. Predictive failure information, project benchmarks information, legacy information, energy use information, preventative maintenance information, and alarm information are as described in [0169].

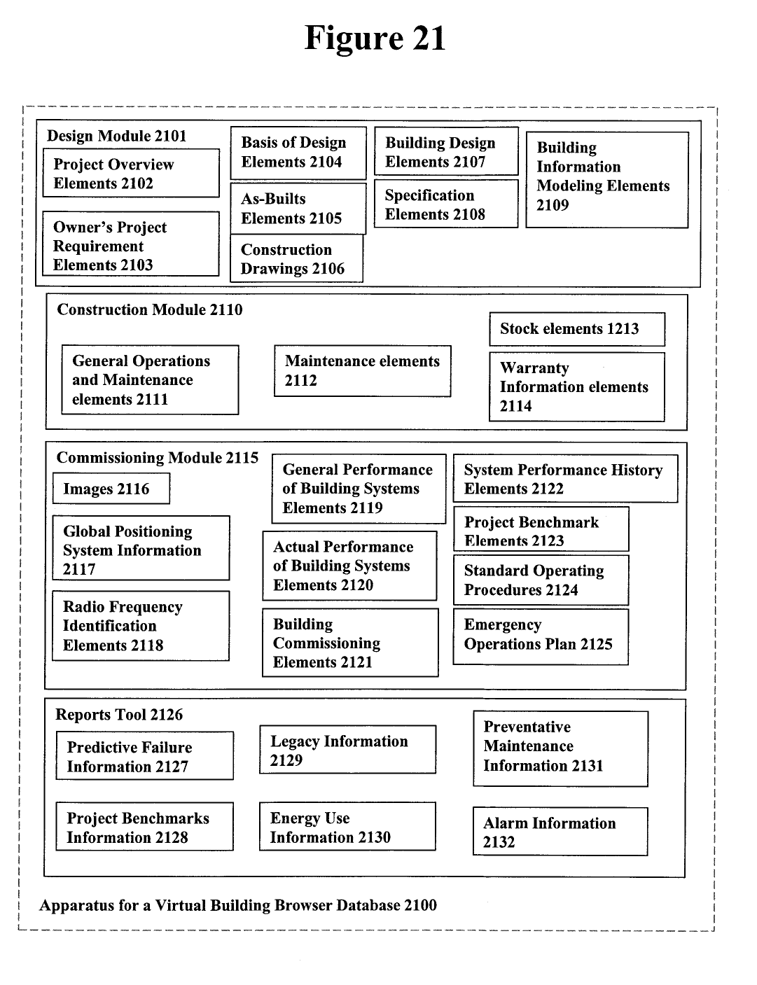

In another embodiment, illustrated in FIG. 21, an apparatus for a virtual building browser database 2100 comprises: a design module 2101, further comprising one or more elements related to a project overview 2102, one or more elements related to the owner's project requirements 2103, one or more elements related to a basis of design 2104, one or more elements related to as-builts 2105, one or more elements related to construction drawings 2106, one or more elements related to building design 2107, one or more elements related to specifications 2108, and one or more elements related to building information modeling 2109; a construction module 2110, further comprising one or more elements related to general operations and maintenance 2111, one or more elements related to maintenance 2112, one or more elements related to stock 2113, and one or more elements related to warranty information 2114; a commissioning module 2115, further comprising one or more images 2116, one or more elements related to global positioning system information 2117, one or more elements related to radio frequency identification tags 2118, one or more elements related to general performance of building systems 2119, one or more elements related to actual performance of building systems 2120, one or more elements related to building commissioning 2121, one or more elements related to system performance history 2122, one or more elements related to project benchmarks 2123, one or more elements related to standard operating procedures 2124, one or more elements related to an emergency operations plan 2125, and a reports tool 2126, further comprising predictive failure information 2127, project benchmarks information 2128, legacy information 2129, energy use information 2130, preventative maintenance information 2131, and alarm information 2132. In another aspect of the previous embodiment, the virtual building browser database is a visual asset management system 2133. Predictive failure information, project benchmarks information, legacy information, energy use information, preventative maintenance information, and alarm information are as described in [0169].

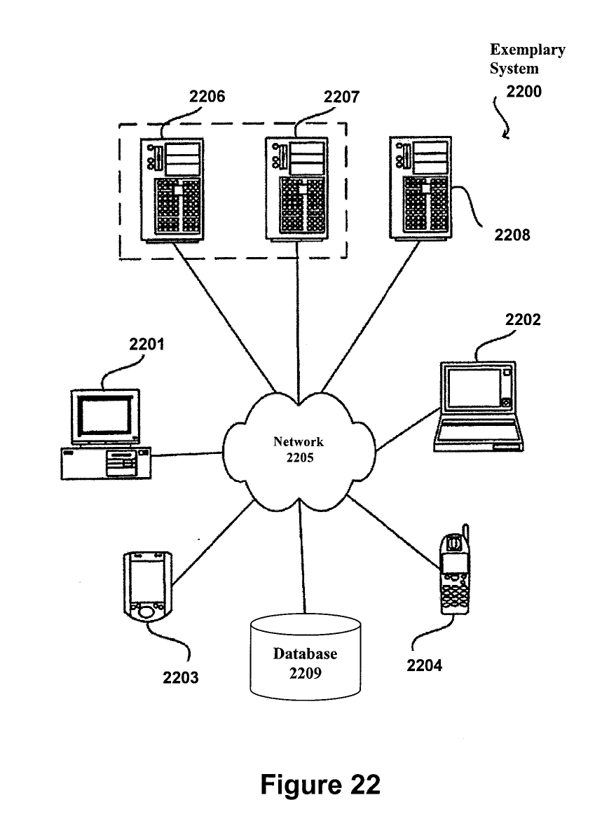

FIG. 22 is a block diagram illustrating components of an exemplary operating environment in which embodiments of the present invention may be implemented. The system 2200 can include one or more user computers, computing devices, or processing devices 2201, 2202, 2203, 2204, which can be used to operate a client, such as a dedicated application, web browser, etc. The user computers 2201, 2202, 2203, 2204 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 2201, 2202, 2203, 2204 may also have any of a variety of applications, including one or more development systems, database client and/or server applications, and Web browser applications. Alternatively, the user computers 2201, 2202, 2203, 2204 may be any other electronic device, such as a thin-client computer, Internet-enabled gaming system, and/or personal messaging device, capable of communicating via a network (e.g., the network 2205 described below) and/or displaying and navigating Web pages or other types of electronic documents. Although the exemplary system 2200 is shown with four user computers, any number of user computers may be supported.

In most embodiments, the system 2200 includes some type of network 2205. The network can be any type of network familiar to those skilled in the art that can support data communications using any of a variety of commercially-available protocols, including without limitation TCP/IP, SNA, IPX, AppleTalk, and the like. Merely by way of example, the network 2205 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 2206, 2207, 2208 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 2208) may be dedicated to running applications, such as a business application, a Web server, application server, etc. Such servers may be used to process requests from user computers 2201, 2202, 2203, 2204. The applications can also include any number of applications for controlling access to resources of the servers 2206, 2207, 2208.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 2201, 2202, 2203, 2204. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 2201, 2202, 2203, 2204.

The system 2200 may also include one or more databases 2209. The database(s) 2209 may reside in a variety of locations. By way of example, a database 1220 may reside on a storage medium local to (and/or resident in) one or more of the computers 2201, 2202, 2203, 2204, 2206, 2207, 2208. Alternatively, it may be remote from any or all of the computers 2201, 2202, 2203, 2204, 2206, 2207, 2208, and/or in communication (e.g., via the network 2205) with one or more of these. In a particular set of embodiments, the database 2209 may reside in a storage-area network (“SAN”) familiar to those skilled in the art. Similarly, any necessary files for performing the functions attributed to the computers 2201, 2202, 2203, 2204, 2206, 2207, 2208 may be stored locally on the respective computer and/or remotely, as appropriate. In one set of embodiments, the database 2209 may be a relational database, such as Oracle 10g, that is adapted to store, update, and retrieve data in response to SQL-formatted commands.

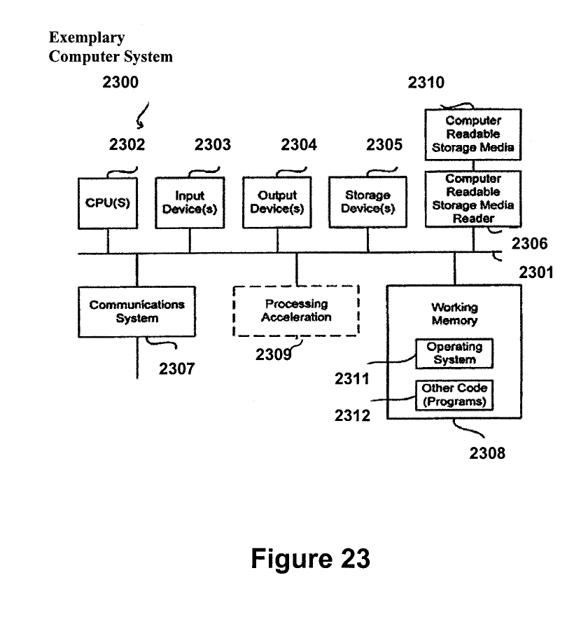

FIG. 23 illustrates an exemplary computer system 2300, in which embodiments of the present invention may be implemented. The system 2300 may be used to implement any of the computer systems described above. The computer system 2300 is shown comprising hardware elements that may be electrically coupled via a bus 2301. The hardware elements may include one or more central processing units (CPUs) 2302, one or more input devices 2303 (e.g., a mouse, a keyboard, etc.), and one or more output devices 2304 (e.g., a display device, a printer, etc.). The computer system 2300 may also include one or more storage devices 2305. By way of example, the storage device(s) 2305 can include devices such as disk drives, optical storage devices, solid-state storage device such as a random access memory (“RAM”) and/or a read-only memory (“ROM”), which can be programmable, flash-updateable and/or the like.

The computer system 2300 may additionally include a non-transitory computer-readable storage media reader 2306, a communications system 2307 (e.g., a modem, a network card (wireless or wired), an infra-red communication device, etc.), and working memory 2308, which may include RAM and ROM devices as described above. In some embodiments, the computer system 2300 may also include a processing acceleration unit 2309, which can include a digital signal processor DSP, a special-purpose processor, and/or the like.

The non-transitory computer-readable storage media reader 2306 can further be connected to a non-transitory computer-readable storage medium 2310, together (and, optionally, in combination with storage device(s) 2305) comprehensively representing remote, local, fixed, and/or removable storage devices plus storage media for temporarily and/or more permanently containing, storing, transmitting, and retrieving non-transitory computer-readable information. The communications system 2307 may permit data to be exchanged with the network and/or any other computer described above with respect to the system 2300.

The computer system 2300 may also comprise software elements, shown as being currently located within a working memory 2308, including an operating system 2311 and/or other code 2312, such as an application program (which may be a client application, Web browser, mid-tier application, RDBMS, etc.). It should be appreciated that alternate embodiments of a computer system 2300 may have numerous variations from that described above. For example, customized hardware might also be used and/or particular elements might be implemented in hardware, software (including portable software, such as applets), or both. Further, connection to other computing devices such as network input/output devices may be employed.

Storage media and non-transitory computer readable media for containing code, or portions of code, can include any appropriate media known or used in the art, including storage media and communication media, such as but not limited to volatile and non-volatile, removable and non-removable media implemented in any method or technology for storage and/or transmission of information such as non-transitory computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 23 further illustrates an environment where an on-demand distributed database service might be used. As illustrated in FIG. 23 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a non-transitory machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

It should also be understood that each application server may be communicably coupled to one or more distributed database systems, e.g., system database and multi-enterprise database(s), via a different network connection to form a peer to peer network. For example, one server might be coupled via the Internet, another server might be coupled via a direct network link, and another server might be coupled by yet a different network connection. Transfer Control Protocol and Internet Protocol (TCP/IP) are typical protocols for communicating between servers and one or more distributed database systems. However, it will be apparent to one skilled in the art that other transport protocols may be used to optimize the system depending on the network interconnect used to implement the peer to peer, distributed network.

Each of the one or more distributed database systems can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

Although illustrative embodiments have been described herein, it should be understood and will be appreciated by those skilled in the art that numerous variations may be made or applied within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

What is claimed is:

1. An apparatus for a virtual tour comprising:
a viewing module that displays an image of at least one of a visible element and one of a hidden element in a first location on an electronic device;
a searchable database comprising a data repository, one or more visible elements and one or more hidden elements, wherein said searchable database is configured in a Construction Operations Building Information Exchange compliant format and wherein one or more data elements are updated in real time; and
a query module wherein one or more data elements are associated with one or more related data elements from the data repository.

2. The apparatus of claim 1, wherein at least one or more data elements associated with the virtual tour is stored on a cloud-accessible server.

3. The apparatus of claim 1, wherein the viewing module includes a three dimensional building information model (BIM) that further comprises images of visible and hidden elements.

4. The apparatus of claim 1, wherein the viewing module displays a hotspot indicator substantially adjacent an element image associated with one or more data elements, and wherein the hotspot indicator is a discernible symbol visible on the electronic device.

5. The apparatus of claim 4, wherein the electronic device display can be touched substantially adjacent to the hotspot indicator to activate retrieval of one or more data elements associated with the element image.

6. The apparatus of claim 1, wherein the user can navigate through displayed element images on the electronic device using photography software to select a menu item from a group consisting of panning, tilting, and zooming.

7. The apparatus of claim 1 further comprising a means for transferring data between the electronic device used for the virtual tour to another electronic device.

8. The apparatus of claim 1 further comprising a means for uploading and storing data and images on the virtual touring device.

9. The apparatus of claim 1 further comprising user-selected elements selected from a group consisting of virtual tour images and data.

10. The apparatus of claim 1 further comprising a reader for identifier 2D and 3D codes such as bar codes and Q codes for controlling access to the virtual tour.

11. The apparatus of claim 1 wherein at least one of a brand name and a logo symbol are visible on the electronic device display during the virtual tour.

12. The apparatus of claim 1 further comprising an alarm module, wherein the alarm module comprises:
a user interface for the user to enter one or more boundaries on an element data value; and
an alarm signal, wherein the alarm signal is at least one of a sound and an image present on the electronic device when the element data value deviates from user-determined boundaries on the element data value.

13. The apparatus of claim 1 further comprising a maintenance scheduling module, wherein the maintenance scheduling module comprises:
a user interface for the user to enter at least one scheduled maintenance time for at least one element; and
a maintenance signal, wherein the maintenance signal is at least one of a sound and an image present on the electronic device when the current time indicated on the electronic device matches the schedule maintenance time for an element.

14. The apparatus of claim 1 further comprising:
a registration module to input user information in a database and to register with said virtual touring system as at least one of a registered user and administrator; and
an access control module for varying each registered user's ability to view images and data visible element images on the electronic device, wherein access for each registered user can be adjusted by one or more administrators.

15. The apparatus of claim 1, further comprising an electric grid capacity module, comprising:
data about the current electric grid capacity in the location;
a user interface for the user to set one or more boundaries on the current electric grid capacity in the location; and
an electric grid capacity signal, wherein the electric grid capacity signal is at least one of a sound and an image present on the electronic device when the value of the current electric grid capacity in the location deviates from the user-determined boundaries on the current electric grid capacity in the location.

16. The apparatus of claim 1, further comprising an electricity price spike module, comprising:
data about the current electricity price for the location;
a user interface for the user to set one or more boundaries on the current electricity price for the location; and
an electricity price signal, wherein the electricity price signal is at least one of a sound and an image present on the electronic device when the current electricity price for the location deviates from the user-determined boundaries on the current electricity price for the location.

17. The apparatus of claim 1, wherein the element data in the searchable database includes Leadership in Energy and Environmental Design (LEED) green building data for a corresponding element.

18. The apparatus of claim 17, further comprising one or more reports associated with one or more elements in a location that includes corresponding LEED green building information.

19. The apparatus of claim 3, wherein the user can navigate through displayed element images on the electronic device using photography software to select a menu item from a group consisting of panning, tilting, and zooming.

20. The apparatus of claim 19, further comprising a red target as a visible red spot on the electronic device display, wherein the electronic device display can be touched substantially adjacent to a red target to make an element image appear larger on the electronic device.

21. The apparatus of claim 19, wherein the viewing module changes the image displayed on the electronic device in response to the user's location, wherein the user's location is determined using global positioning system or Google Earth-linked functions.

22. The apparatus of claim 19, wherein an internal gyroscope within the electronic device senses changes in the position of the electronic device, and causes changes in the element images displayed on the electronic device in response to these changes in the position of the electronic device.

23. The apparatus of claim 12 wherein the user interface is a building tour user interface for one or more users to access one or more building information management database repositories utilizing a digital computing device.

24. The apparatus of claim 23 wherein the digital computing device is an iPad tablet computing device.

25. The apparatus of claim 1, further comprising a regulatory module, wherein the regulatory module allows the user or a third-party to associate the element data in the searchable database with updated regulatory data for a corresponding element in the corresponding location.

26. The apparatus of claim 25, wherein the updated regulatory data is updated building code data for a corresponding element in the corresponding location.

27. A non-transitory computer-usable readable storage medium for conducting a virtual tour comprising:
program code for displaying an image of one or more visible elements in a location on an electronic displays;
program code for displaying an image of one or more hidden elements in a location on one or more electronic displays;
program code for storing and organizing element data in a format based on the approach of the Construction Operations Building Information Exchange; and
program code for retrieving the element data for one or more systems of related elements through user interactions with at least one element image on the electronic device.

28. The non-transitory computer-usable readable storage medium for conducting a virtual tour of claim 27, further comprising:
program code for associating one or more source data elements with one or more related target data elements from the data repository;
program code for accessing building information status data in real time via one or more peripheral input devices and one or more display devices;
program code for linking one or more integration applications to the searchable, relational database with one or more associated databases, wherein the one or more associated databases comprise one or more disparate protocol and one or more disparate domains; and
program code for associating a virtual tour with a virtual building browser comprising a cloud-based software network application;
program code for interfacing the virtual tour with an iPad electronic device and an iPad iOS operating system;
program code for populating one or more operation and maintenance manuals into a building information data repository associated with the one or more searchable, relational databases and one or more physical asset elements;
program code for tracking a user's movement in a facility where the user is located; and
program code for activating a virtual touring application to render the touring application functional.

29. The non-transitory computer-usable readable storage medium for conducting a virtual tour of claim 28, wherein the program code for tracking a user's movement in a facility allows for viewing a facility virtual tour by a user who is not physically present in the facility being viewed.

30. The non-transitory computer-usable readable storage medium for conducting a virtual tour of claim 29, further comprising:
program code for providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets;
program code for viewing on or more hidden elements;
program code for providing a three dimensional building information model;
program code for providing a video tour model; and
program code for associating photography software application with the video tour model to render one or more visible and one or more hidden elements of the facility virtual tour and a related building information model.

31. A method for providing a virtual tour comprising:
displaying an image of one or more visible elements in a location on an electronic device;
displaying an image of one or more hidden elements in a location on an electronic device;
storing element data into a database that can organize elements that are Construction Operations Building Information Exchange compliant; and
retrieving element data for one or more systems of related elements through user interactions with the element images on the electronic device.

32. The method of claim 31 for providing a virtual tour, further comprising:
associating one or more source data elements with one or more related target data elements from the data repository;
accessing building information status data in real time via one or more peripheral input devices and one or more display devices;
linking one or more integration applications to the searchable, relational database with one or more associated databases, wherein the one or more associated databases comprise one or more disparate protocol and one or more disparate domains.

33. The method of claim 32 for providing a virtual tour, further comprising:
associating a virtual tour with a virtual building browser comprising a cloud-based software network application;
interfacing the virtual tour with an iPad electronic device and an iPad iOS operating system;
populating one or more operation and maintenance manuals into a building information data repository associated with the one or more searchable, relational databases and one or more physical asset elements;
tracking a user's movement in a facility where the user is located; and
activating a virtual touring application to render the touring application functional.

34. The method of claim 33 for providing a virtual tour, wherein the tracking a user's movement in a facility allows for viewing a facility virtual tour by a user who is not physically present in the facility being viewed.

35. The method of claim 34 for providing a virtual tour, further comprising:
providing an operating mode for touring while physically located within a facility with physical asset elements associated with the one or more searchable, relational databases and that includes a selected point of reference location to subsequently create a facility profile, wherein said operating mode is selected from the group consisting of a manual mode, auto-locate mode, and a GPS mode.

36. The method of claim 35 for providing a virtual tour, wherein the manual mode includes a manually selected point of reference location.

37. The method of claim 35 for providing a virtual tour, wherein the auto-locate mode uses a feature that determines the facility location of one or more pre-identified, recognized facility assets.

38. The method of claim 35 for providing a virtual tour, wherein the GPS mode includes a GPS device integrated with the iPad iOS operating system.

39. The method of claim 35 for providing a virtual tour, further comprising:
providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets.

40. The method of claim 39 for providing a virtual tour, further comprising viewing one or more hidden elements.

41. The method of claim 40 for providing a virtual tour, further comprising providing a three dimensional building information model.

42. The method of claim 41 for providing a virtual tour, further comprising:
providing a video tour model; and
associating photography software application with the video tour model to render one or more visible and one or more hidden elements of the facility virtual tour and a related building information model.

43. A virtual touring system comprising:
a database module that organizes element data that is Construction Operations Building Information Exchange compliant;
a viewing module that displays images of one or more visible elements and one or more hidden elements in a location on an electronic device; and
a data retrieval module for fetching element data from the database module in response to user interaction with the viewing module.

44. The virtual touring system of claim 43, further comprising:
a searchable, relational database comprising a data repository, one or more visible elements and one or more hidden elements, wherein said searchable, relational database is configured in a Construction Operations Building Information Exchange (COBie) compliant format wherein the COBie compliant data is synchronized with one or more additional COBie compliant searchable, relational databases and wherein one or more data elements are updated in real time;
a query module wherein one or more data elements are associated with one or more related data elements from the data repository;
an access interface tool for retrieving and updating building information status data in real-time;
one or more control monitoring systems of maintenance, repair, and operation data to manage facility assets;
one or more integration applications to link the searchable database with one or more associated databases;
one or more peripheral input devices; and
one or more display devices.
a viewing module for displaying an image of at least one of a visible element and one of a hidden element in a first location on an electronic device.

45. The virtual touring system of claim 44, further comprising a cloud-based software network application.

46. The virtual touring system of claim 45 wherein the access interface tool for retrieving and updating building information status data in real-time is an asset management tool.

47. The virtual touring system of claim 46 wherein the viewing module is a touring application.

48. One or more processor-readable storage devices having processor readable code embodied on at least one processor readable storage device, said processor readable code for causing at least one processor readable storage device to perform a method of conducting a virtual tour comprising steps for:
displaying an image of one or more visible elements in a location on an electronic device;
displaying an image of one or more hidden elements in a location on an electronic device;
storing element data into a database that can organize systems of related elements based on the approach of the Construction Operations Building Information Exchange; and
retrieving element data for one or more systems of related elements from the database in response to user interactions with the element images on the electronic device.

49. The one or more processor-readable storage devices having processor readable code embodied on at least one processor readable storage device, said processor readable code for causing at least one processor readable storage device to perform a method of conducting a virtual tour of claim 48, further comprising steps for:
associating one or more source data elements with one or more related target data elements from the data repository;
accessing building information status data in real time via one or more peripheral input devices and one or more display devices; and
linking one or more integration applications to the searchable, relational database with one or more associated databases, wherein the one or more associated databases comprise one or more disparate protocol and one or more disparate domains.

50. The one or more processor-readable storage devices having processor readable code embodied on at least one processor readable storage device, said processor readable code for causing at least one processor readable storage device to perform a method of conducting a virtual tour of claim 48, further comprising steps for:
associating a virtual tour with a virtual building browser comprising a cloud-based software network application;
interfacing the virtual tour with an iPad electronic device and an iPad iOS operating system;
populating one or more operation and maintenance manuals into a building information data repository associated with the one or more searchable, relational databases and one or more physical asset elements;
tracking a user's movement in a facility where the user is located; and
activating a virtual touring application to render the touring application functional.

51. The one or more processor-readable storage devices having processor readable code embodied on at least one processor readable storage device, said processor readable code for causing at least one processor readable storage device to perform a method of conducting a virtual tour of claim 48, further comprising steps for:
providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets;
providing an iPad electronic tablet device integrated with the iPad iOS operating system;
viewing one or more hidden elements;
providing a three dimensional building information model;
providing a video tour model; and
associating photography software application with the video tour model to render one or more visible and one or more hidden elements of the facility virtual tour and a related building information model.

52. A computer-implemented method including computer-usable readable storage medium having computer-readable program code embodied therein for causing a computer system to perform a method of providing a system for a virtual tour comprising steps for:
displaying an image of one or more visible elements in a location on an electronic device;
displaying an image of one or more hidden elements in a location on an electronic device;
storing element data into a database that can organize elements based on the approach of the Construction Operations Building Information Exchange; and
retrieving element data for one or more systems of related elements through user interactions with the element images on the electronic device.

53. The computer-implemented method of claim 52, including computer-usable readable storage medium having computer-readable program code embodied therein for causing a computer system to perform a method of providing a system for a virtual tour, further comprising steps for:
associating one or more source data elements with one or more related target data elements from the data repository;
accessing building information status data in real time via one or more peripheral input devices and one or more display devices; and
linking one or more integration applications to the searchable, relational database with one or more associated databases, wherein the one or more associated databases comprise one or more disparate protocol and one or more disparate domains.

54. The computer-implemented method of claim 53, including computer-usable readable storage medium having computer-readable program code embodied therein for causing a computer system to perform a method of providing a system for a virtual tour, further comprising steps for:
associating a virtual tour with a virtual building browser comprising a cloud-based software network application;
interfacing the virtual tour with an iPad electronic device and an iPad iOS operating system;
populating one or more operation and maintenance manuals into a building information data repository associated with the one or more searchable, relational databases and one or more physical asset elements;
tracking a user's movement in a facility where the user is located; and
activating a virtual touring application to render the touring application functional.

55. The computer-implemented method of claim 54, including computer-usable readable storage medium having computer-readable program code embodied therein for causing a computer system to perform a method of providing a system for a virtual tour, further comprising steps for:
providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets;
providing an iPad electronic tablet device integrated with the iPad iOS operating system;
viewing on or more hidden element;
providing a three dimensional building information model;
providing a video tour model; and
associating photography software application with the video tour model to render one or more visible and one or more hidden elements of the facility virtual tour and a related building information model.

56. A computer-implemented platform including a non-transitory computer-usable readable storage medium having non-transitory computer-readable program codes embodied therein for causing a computer system to provide steps for a virtual tour system, comprising:
a custom computer platform for a virtual building browser;
a user interface module having a display, wherein the display graphically associates one or more data elements from a relational, searchable database with one or more physical assets in a building information model;
the relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time;
a query module wherein one or more data elements are associated with one or more related data elements from the data repository;
an access interface tool for retrieving and updating building information status data in real-time;
one or more control monitoring systems of maintenance, repair, and operation data to manage facility assets;
one or more integration applications to link the searchable database with one or more associated databases;
one or more peripheral input devices; and
one or more display devices.

57. A computer-implemented apparatus for providing a method of performing a virtual tour, said apparatus comprising:
a viewing module that displays an image of at least one of a visible element and one of a hidden element in a first location on an electronic device;
a searchable database comprising a data repository, one or more visible elements and one or more hidden elements, wherein said searchable database is configured in a Construction Operations Building Information Exchange compliant format and wherein one or more data elements are updated in real time; and
a query module wherein one or more data elements are associated with one or more related data elements from the data repository, wherein at least one or more data elements associated with the virtual tour is stored on a cloud-accessible server, and wherein the viewing module includes a three dimensional building information model (BIM) that further comprises images of visible and hidden elements wherein the viewing module indicates an element image associated with one or more data elements by displaying a hotspot indicator near the element image, wherein the hotspot indicator is a discernible, visible symbol on the electronic device.

58. A method for displaying a building information management image of a location on an electronic device comprising:
providing at least one of a 2D and 3D image associated with one or more physical assets configured in a searchable, relational database and further associated with extended information attributes of the one or more physical assets discoverable by an iPad electronic tablet device integrated with an iPad iOS operating system;
displaying visible elements;
indicating hidden elements;
changing a page view of said hidden elements and said visible elements associated with a point of reference location in real time;
changing a page view of said hidden elements and said visible elements associated with a point of reference of the iPad electronic tablet device orientation in real time wherein said iPad electronic tablet device orientation is determined with respect to a three dimensional axis to a point in space;
providing a visual mark substantially near one or more elements linked to element data stored in a database; and
retrieving element data from a database in response to a user's interaction with the electronic device.

59. The method of claim 58 for displaying a building information management image of a location on an electronic device wherein the point of reference location is a user physical location.

60. The method of claim 58 for displaying a building information management image of a location on an electronic device wherein the point of reference location is a user virtual location.

61. The method claim 60 for displaying a building information management image of a location on an electronic device wherein the point of reference location is a user virtual location determined by a GPS embedded software application.

62. A method for viewing building operations data comprising steps for:
associating one or more source data elements with one or more related target data elements from the data repository;
accessing building information status data in real time via one or more peripheral input devices and one or more display devices; and
linking one or more integration applications to the searchable, relational database with one or more associated databases, wherein the one or more associated databases comprise one or more disparate protocol and one or more disparate domains;
associating a virtual tour with a virtual building browser comprising a cloud-based software network application;
interfacing the virtual tour with an iPad electronic device and an iPad iOS operating system;
populating one or more operation and maintenance manuals into a building information data repository associated with the one or more searchable, relational databases and one or more physical asset elements;
tracking a user's movement in a facility where the user is located; and
activating a virtual touring application to render the touring application functional;
providing a hotspot indicator for associating one or more facility assets with one or more database elements, wherein the hotspot indicator may be configured to open a separate dialog box to render extended information related to the associated one or more database elements with the corresponding one or more facility assets in one or more physical locations substantially adjacent to the corresponding one or more facility assets;
providing an iPad electronic tablet device integrated with the iPad iOS operating system;
viewing on or more hidden elements;
providing a three dimensional building information model;
providing a video tour model; and
associating photography software application with the video tour model to render one or more visible and one or more hidden elements of the facility virtual tour and a related building information model.

63. A method for linking green building data to a virtual rendering of a location comprising:
linking LEED information to a symbol visible on an electronic device display substantially near an element;
creating a LEED credit report using element images and element data;
providing one or more Leadership in Energy and Environmental Design attributes for green building and facilities operations practices, one or more LEED certification program attributes for existing and new construction;
providing a link symbol for each one or more attribute to an external website with extended information about that element or sub-system, wherein said external website is associated with a custom computer platform for a virtual building browser;
associating one or more data elements from a relational, searchable database with one or more physical assets in a building information model;
providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time;
providing a query module wherein one or more data elements are associated with one or more related data elements from the data repository;
retrieving and updating building information status data in real-time;
providing one or more control monitoring systems of maintenance, repair, and operation data to manage facility assets;
providing one or more integration applications to link the searchable database with one or more associated databases;
accessing one or more peripheral input devices; and
displaying building information data on one or more electronic devices.

64. A method for linking green building data to a database of information about elements in a location comprising:
updating a database of element data with associated LEED information linked to specific elements with keywords;
linking LEED information to the element data stored on the database;
creating a LEED credit report using visual images and data stored in the database;
incorporating a signal on virtual building browser that indicates when an associated electric grid capacity is high;
incorporating a signal on the virtual building browser that indicates when electricity prices are high;
providing one or more Leadership in Energy and Environmental Design attributes for green building and facilities operations practices, one or more LEED certification program attributes for existing and new construction;
providing a link symbol for each one or more attribute to an external website with extended information about that element or sub-system, wherein said external website is associated with a custom computer platform for a virtual building browser;
associating one or more data elements from a relational, searchable database with one or more physical assets in a building information model;
providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time;
providing a query module wherein one or more data elements are associated with one or more related data elements from the data repository;
retrieving and updating building information status data in real-time;
providing one or more control monitoring systems of maintenance, repair, and operation data to manage facility assets;
providing one or more integration applications to link the searchable database with one or more associated databases;
accessing one or more peripheral input devices; and
displaying building information data on one or more electronic devices.

65. A method for linking a virtual touring device to regulatory data about elements in a location comprising:
updating a database of element data with associated building code information linked to specific elements with keywords;
linking building code information to the element data stored on the database;
creating a building code test report using visual images and data stored in the database;
providing one or more building code attributes for existing and new construction;
providing a link symbol for each one or more attribute to an external website with extended information about that element or sub-system, wherein said external website is associated with a custom computer platform for a virtual building browser;
associating one or more data elements from a relational, searchable database with one or more physical assets in a building information model;
providing a relational, searchable database for storing element data in a data repository comprising one or more physical asset attributes extended information for accessing building information status data in real time via one or more peripheral input devices and one or more display devices wherein the data repository associates one or more physical asset extended information attributes to one or more visible elements and one or more hidden elements, and wherein said searchable, relational database is configured in a Construction Operations Building Information Exchange (COBie) compliant format that includes COBie compliant data, and wherein the COBie compliant data is synchronized with one or more additional COBie compliant searchable, relational databases and wherein one or more data elements are updated in real time;
providing a query module wherein one or more data elements are associated with one or more related data elements from the data repository;
retrieving and updating building information status data in real-time;
providing one or more control monitoring systems of maintenance, repair, and operation data to manage facility assets;
providing one or more integration applications to link the searchable database with one or more associated databases;
accessing one or more peripheral input devices; and
displaying building information data on one or more electronic devices.

66. A virtual building browser, comprising:
a viewing module that displays an image of at least one of a visible element and one of a hidden element in a first location on an electronic device;
a searchable, relational database comprising a data repository, one or more visible elements and one or more hidden elements, wherein said searchable database is configured in a Construction Operations Building Information Exchange compliant format and wherein one or more data elements are updated in real time;
a query module wherein one or more data elements are associated with one or more related data elements from the data repository;
an access interface tool for retrieving and updating building information status data in real-time;
one or more control monitoring systems of maintenance, repair, and operation data to manage facility assets;
one or more integration applications to link the searchable database with one or more associated databases;
one or more peripheral input devices; and
one or more display devices.

67. The virtual building browser of claim 66, further comprising a cloud-based software network application.

68. The virtual building browser of claim 67 wherein the access interface tool for retrieving and updating building information status data in real-time is an asset management tool.

69. The virtual building browser of claim 68 wherein the asset management tool populates one or more searchable operation and maintenance manuals into the building information status data repository during the design and construction process.

70. The virtual building browser of claim 69, wherein the viewing module that displays an image of at least one of a visible element and one of a hidden element in a first location on an electronic device, is a touring application.

71. The virtual building browser of claim 70, further comprising:
an iPad iOS operating system interface;
an operating mode, located in a facility wherein the user is located and that is used for tracking a user's movement, includes a selected point of reference location and a subsequently tracked user's facility movement profile; and
an activation selector that is in the open position to render the touring application functional.

72. The virtual building browser of claim 71, wherein the operating mode is a manual mode that includes a manually selected point of reference location.

73. The virtual building browser of claim 72, wherein the operating mode is an auto-locate feature that determines the facility location of one or more pre-identified, recognized facility assets.

74. The virtual building browser of claim 73, further comprising:
a GPS mode for tracking a user's movement in a facility wherein the user is located by a GPS device integrated with the iPad iOS operating system;
the auto-locate feature operating mode of claim 73; and
the manual mode operating mode of claim 72.

75. The virtual building browser of claim 74, further comprising:
a hotspot indicator to associate one or more facility assets with one or more database elements, wherein the hotspot indicator may be configured to open a separate dialog box to render extended information related to the associated one or more database elements with the corresponding one or more facility assets in a physical location substantially adjacent to the corresponding one or more facility assets.

76. The virtual building browser of claim 75, wherein a user located in the facility in a stationary position can view one or more hidden elements.

77. The virtual building browser of claim 76, further comprising a three dimensional building information model.

78. The virtual building browser of claim 77, further comprising a video tour model.

79. The virtual building browser of claim 78, further comprising:
a photography software application associated with the video tour model to render one or more visible and one or more hidden elements of the virtual building browser and wherein the photography software integrates to one or more of the searchable, relational database elements to associate viewable elements in the video tour model with associated extended information in the one or more visible and the one or more hidden elements of the virtual building browser.

80. The virtual building browser of claim 79, wherein the photography software alternatively includes pan, tilt and zoom functions, to view live and archived data of the one or more visible and one or more hidden elements of the virtual building browser by tapping a hotspot indicator.

81. The virtual building browser of claim 80, further comprising a regulatory module, wherein the regulatory module allows the user or a third-party to associate the element data in the searchable database with updated regulatory data for a corresponding element in the corresponding location.

82. The virtual building browser of claim 81, wherein the updated regulatory data is updated building code data for a corresponding element in the corresponding location.

83. A method for synchronizing two or more users to simultaneously access extended information about a field site from one or more remote locations, comprising:
displaying an image of one or more visible elements in a location on two or more electronic devices;
displaying an image of one or more hidden elements in a location on two or more electronic devices;
storing element data into a database that can organize elements that are Construction Operations Building Information Exchange compliant;
retrieving element data for one or more systems of related elements through each user's interactions with the element images on each of the two or more electronic devices;
associating one or more source data elements with one or more related target data elements from the data repository;
accessing building information status data in real time via one or more peripheral input devices and one or more display devices;
linking one or more integration applications to the searchable, relational database with one or more associated databases, wherein the one or more associated databases comprise one or more disparate protocols and one or more disparate domains;
associating at least one electronic device with a cloud-based software network application; and
populating one or more operation and maintenance manuals into a building information data repository associated with the one or more searchable, relational databases and one or more physical asset elements.

84. The method of claim 83, wherein at least one electronic device is an iPad electronic device with an iPad iOS operating system.

85. The method of claim 83, wherein one electronic device is tracking a user's movement in a facility where the user is located, wherein tracking a user's movement in a facility allows remote viewing of a facility by a user who is not physically present in the facility being viewed.

86. A method for directly comparing a virtual rendering and commissioning data from two different locations comprising:
displaying an image of one or more visible and hidden elements in a first location on an electronic device;
displaying an image of one or more visible and hidden elements in a second location on the same electronic device;
storing element data for each location into a database that can organize elements that are Construction Operations Building Information Exchange compliant;
retrieving element data for one or more systems of related elements through each user's interactions with the element images on the electronic device;
associating one or more source data elements with one or more related target data elements from the data repository;
accessing building information status data in real time via one or more peripheral input devices and one or more display devices;
linking one or more integration applications to the searchable, relational database with one or more associated databases, wherein the one or more associated databases comprise one or more disparate protocols and one or more disparate domains;
associating the electronic device with a cloud-based software network application; and
populating one or more operation and maintenance manuals into a building information data repository associated with the one or more searchable, relational databases and one or more physical asset elements.

87. The method of claim 86, wherein the electronic device is an iPad electronic device with an iPad iOS operating system.

88. The method of claim 87, wherein the electronic device is tracking a user's movement in a facility where the user is located, wherein tracking a user's movement in a facility allows remote viewing of a facility by a user who is not physically present in the facility being viewed.

89. An apparatus for a virtual building browser database, comprising:
a building object, further comprising:
a building identification field;
a building name field;
one or more address fields; and
a user-defined building information field;
one or more building owner network objects corresponding to the building object, each further comprising:
a building owner network identification field;
an owner identification field;
the building identification field; and
a user-defined building owner network information field;
an owner object corresponding to one or more building owner network objects, further comprising:
the corresponding owner identification field;
one or more owner name fields;
one or more owner contact fields;
one or more owner phone fields; and
a user-defined owner information field;
a facility network object corresponding to the building object, further comprising:
a facility network identification field;
a facility identification field;
the building identification field; and
a user-defined facility network information field;
a facility object corresponding to one or more facility network objects, further comprising:
the corresponding facility identification field;
a facility name field; and
at least one facility location field;
one or more floor objects corresponding to the building object, each further comprising:
a floor identification field;
the building identification field;
a floor name field,
a floor area field; and
a user-defined floor information field;
one or more location objects corresponding to a floor object, each further comprising:
a location identification field;
the floor identification field;
a location name field;
a geo-location field;
a location area field; and
a user-defined location information field;
one or more plant location objects corresponding to a location object, each further comprising:
a plant location identification field;
the location identification field;
a plant identification field; and
a user-defined plant location information field;
a plant object corresponding to one or more plant location objects, further comprising:
the corresponding plant identification field;
a parent-plant identification field;
at least one plant name field;
a manufacture identification field;
a product code field; and
a user-defined plant information field;
a manufacturer object corresponding to one or more plant objects, further comprising:
the corresponding manufacturer identification field;
at least one manufacturer name field;
a contact field; and
a user-defined manufacturer information field.

90. The apparatus of claim 89, wherein the virtual building browser database is a virtual asset management system.

91. A method of providing a virtual building browser database comprising:
providing one or more elements related to a project overview;
providing one or more elements related to the owner's project requirements;
providing one or more elements related to a basis of design;
providing an as-builts tool, further comprising:
one or more elements related to as-builts;
one or more elements related to construction drawings;
one or more elements related to specifications;
one or more elements related to building information modeling;
one or more images;
one or more elements related to global positioning system information; and
one or more elements related to radio frequency identification tags;
providing a general performance tool, further comprising:
one or more elements related to general performance of building systems;
one or more elements related to building design;
one or more elements related to actual performance of building systems;
one or more elements related to building commissioning;
one or more elements related to system performance history; and
one or more elements related to project benchmarks;
providing a general operations and maintenance tool, further comprising:
one or more elements related to general operations and maintenance;
one or more elements related to standard operating procedures;
one or more elements related to an emergency operations plan;
one or more elements related to maintenance;
one or more elements related to stock; and
one or more elements related to warranty information;
providing a reports tool, further comprising:
predictive failure information;
project benchmarks information;
legacy information;
energy use information;
preventative maintenance information; and
alarm information.

92. The method of claim 91 wherein the virtual building browser database is a visual asset management system.

93. A method of providing a virtual building browser database comprising:
providing a design module, further comprising:
one or more elements related to a project overview;
one or more elements related to the owner's project requirements;
one or more elements related to a basis of design;
one or more elements related to as-builts;
one or more elements related to construction drawings;
one or more elements related to building design;
one or more elements related to specifications; and
one or more elements related to building information modeling;
providing a construction module, further comprising:
one or more elements related to general operations and maintenance;
one or more elements related to maintenance;
one or more elements related to stock; and
one or more elements related to warranty information;
providing commissioning module, further comprising:
one or more images;
one or more elements related to global positioning system information;
one or more elements related to radio frequency identification tags;
one or more elements related to general performance of building systems;
one or more elements related to actual performance of building systems;
one or more elements related to building commissioning;
one or more elements related to system performance history;
one or more elements related to project benchmarks;
one or more elements related to standard operating procedures;
one or more elements related to an emergency operations plan; and
a reports tool, further comprising:
predictive failure information;
project benchmarks information;
legacy information;
energy use information;
preventative maintenance information; and
alarm information.

94. The method of claim 93 wherein the virtual building browser database is a visual asset management system.

95. An apparatus for a virtual building browser database comprising:
one or more elements related to a project overview;
one or more elements related to the owner's project requirements;
one or more elements related to a basis of design;
an as-builts tool, further comprising:
one or more elements related to as-builts;
one or more elements related to construction drawings;
one or more elements related to specifications;
one or more elements related to building information modeling;
one or more images;
one or more elements related to global positioning system information; and
one or more elements related to radio frequency identification tags;
a general performance tool, further comprising:
one or more elements related to general performance of building systems;
one or more elements related to building design;
one or more elements related to actual performance of building systems;
one or more elements related to building commissioning;
one or more elements related to system performance history; and
one or more elements related to project benchmarks;
a general operations and maintenance tool, further comprising:
one or more elements related to general operations and maintenance;
one or more elements related to standard operating procedures;
one or more elements related to an emergency operations plan;
one or more elements related to maintenance;
one or more elements related to stock; and
one or more elements related to warranty information;
a reports tool, further comprising:
predictive failure information;
project benchmarks information;
legacy information;
energy use information;
preventative maintenance information; and
alarm information.

96. The apparatus of claim 95 wherein the virtual building browser database is a visual asset management system.

97. An apparatus for a virtual building browser database comprising:
a design module, further comprising:
one or more elements related to a project overview;
one or more elements related to the owner's project requirements;
one or more elements related to a basis of design;
one or more elements related to as-builts;
one or more elements related to construction drawings;
one or more elements related to building design;
one or more elements related to specifications; and
one or more elements related to building information modeling;
a construction module, further comprising:
one or more elements related to general operations and maintenance;
one or more elements related to maintenance;
one or more elements related to stock; and
one or more elements related to warranty information;
a commissioning module, further comprising:
one or more images;
one or more elements related to global positioning system information;
one or more elements related to radio frequency identification tags;
one or more elements related to general performance of building systems;
one or more elements related to actual performance of building systems;
one or more elements related to building commissioning;
one or more elements related to system performance history;
one or more elements related to project benchmarks;
one or more elements related to standard operating procedures;
one or more elements related to an emergency operations plan; and
a reports tool, further comprising:
predictive failure information;
project benchmarks information;
legacy information;
energy use information;
preventative maintenance information; and
alarm information.

98. The apparatus of claim 97 wherein the virtual building browser database is a visual asset management system.
